(19) United States
(12) Patent Application Publication
(10) Pub. No.: US 2015/0046359 A1
(43) Pub. Date: Feb. 12, 2015

(54) SYSTEM AND A METHOD FOR THE DETERMINATION OF THE REPUTATIONAL RATING OF NATURAL AND LEGAL PERSONS

(71) Applicants: Eduardo Marotti, Roma (IT); Jacopo Marotti, Roma (IT); Maria Vittoria Marotti, Roma (IT); Bruno Frattasi, Roma (IT)

(72) Inventors: Eduardo Marotti, Roma (IT); Jacopo Marotti, Roma (IT); Maria Vittoria Marotti, Roma (IT); Bruno Frattasi, Roma (IT)

(21) Appl. No.: 13/960,638

(22) Filed: Aug. 6, 2013

(51) Int. Cl. G06Q 50/26; G06F 17/30

(52) U.S. Cl. CPC G06Q 50/265; G06F 17/3053
USPC 705/325

(57) ABSTRACT

A method for the determination of the reputational rating of natural or legal persons, including the following steps: populating a database with certain pieces of information relating to the natural or legal persons, the certain pieces of information being pertinent to prove evidence or facts object of the evaluation of the reputational rating, assigning a positive or negative weighted value to each of the certain pieces of information, proportional to a suitability factor of the evidence or facts to contribute to the determination; determining the reputational rating of any of the natural or legal persons by summing up all the contributions derived from the weighted values relating to the natural or legal persons.

### BACKGROUND OF THE INVENTION

1. Field of the Invention

The present invention relates to a system and method for the determination of the reputational rating of natural and legal persons.

2. Description of the Prior Art

The Reputation is an essential asset for the purpose of human activities in terms of ensuring the security of social and economic transactions that take place between individuals and legal entities, on the basis of which feelings as well as opinions of reciprocal trust are created and fuelled.

In the light of ever faster and more uncontrollable ways in which true as well as false information is distributed about anyone or anything all over the world, there is a clear need to assess, measure and classify the value to the of reputation, transforming it from a “key capital social asset” to a “key economic asset”, and from “subjective perception” to “objective element”, with the result of generating an asset that is new, exclusive, totally widespread, measurable in its value.

The core of the technical problem preventing the reputation of persons from being objective, gradual, measurable and comparable, is that—to date—the reputation has just been a matter of quality and not quantity.

There is no evidence in the prior art of tentative solutions to that problem.

For example WO-2013/003603-A discloses a method for deriving a hit visibility score for one or more hits from an information source, wherein the one or more hits are directed to a target entity, and wherein the hit visibility score indicates a likelihood that a corresponding hit is found by a searcher after searching for the target entity in the information source. A sentiment module derives a hit sentiment score for the hits; the hit sentiment score indicates a sentiment about the target entity conveyed by the hits; a reputation module derives a reputation for the target entity based on the hit visibility score and the hit sentiment score.

US-2011/153551-A1 discloses a method for analyzing information about a user obtaining search results based on search terms describing the user; it presents the search results to the user and receives an indication from the user of the desirability of a search result. The method also determines a reputation score representing the reputation of the user, including collecting search results from data source, determining an effect on the reputation of the user of the search results from the data source, and calculating a reputation score for the user based on the determined effect on the reputation of the user from the search results from the data source.

The known methods are not suitable for overcoming the above wider problems addressed by this invention, as they cannot give a certain value to all the elements that constitute the reputation. They are not able to define a logical process that brings together all the evaluation elements and extrapolate from them a reputational rating that is understood as creating value from them, and as such being comparable and reliable.

### SUMMARY OF THE INVENTION

The aim of the present invention is to provide a system and method for the determination of the reputational rating of natural and legal persons, able to address and solve the above described problems.

In the framework of the present invention, the term natural person means human individuals of any type and age; the term “private legal person” comprises, but is not limited to, any private legal entity such as any profit or non-profit private entity, company, corporation, foundation, association; the term “public legal person” comprises, but is not limited to, any public entity or authority or government, such as a State, territorial or regional or local authority and/or municipality and administration, as well as publicly appointed and/or recognized organizations, foundations and associations.

The basic idea of the invention is to determine the parameter “reputational rating” of a subject in reference to certain documents that prove the facts being object of the reputational analysis, made on the basis of metadata (obtained from Evidence, as defined below). A numeric value is assigned to the metadata that the software algorithm processes up to determine the rating which, in turn, determines the economic asset attributed to each one? person being analyzed.

Preferably metadata are composed by the specific type of the instance and the values of its enumerated attributes of each evidence, as defined below.

The solution proposed by the invention, through an elaboration of the metadata supported by suitable documents (evidence), produces objective reputational ratings, establishing an infallible, incorruptible, final proof of the reputation.

The system object of the invention provides for the creation of a center for evaluation of reputational risk through the development of metadata (analysis of evidence) supported by documents which, thanks to the software solution and the originality of the adopted parameters, render the reputation objective and measurable, producing a reputational rating which is universally recognized, capable of being the comparison element among all possible subjects under evaluation.

The system object of the invention guarantees to all natural and legal persons the right to security of social and economic transactions they are engaged in. The effectiveness of that right is protected by a system of accreditation of reputation that responds to the principles of objectivity, transparency and widespread public control.

The system object of the invention has a great impact on the economy, primarily as the capitalist system is essentially based on mutual trust, and the invention provides an immediate certification and quantification of the respective reputations of the involved entities. Second, even in social terms, the invention allows to immediately estimate the risk of the interrelation, which is even more important in the web context where the customs and traditions have accelerated the confidential interrelations without any effective protection network.

In addition the system of the invention allows the subject (certified party) to enjoy more favorable economic conditions, in certain activities to be performed in the public sector, i.e. public administration.

According to an aspect of the present invention it is provided a method for the determination of the reputational rating of natural or legal persons, comprising the following steps:

populating a database with certain pieces of information relating to said natural or legal persons, said certain pieces of information being pertinent to prove evidence or facts object of the evaluation of the reputational rating,

assigning a positive or negative weighted value to each of said certain pieces of information, proportional to a suitability factor of said evidence or facts to contribute to said determination;

determining said reputational rating of any of said natural or legal persons by summing up all the contributions derived from the weighted values relating to said natural or legal persons.

Preferably said step of assigning a positive or negative weighted value to each of said certain pieces of information comprises the following steps:

building up a tree structure in said database comprising: type of person, namely natural, or private legal person or public legal person; categories of evidence or facts for each type of person, subcategory of evidence or facts for each category, eventually classes of evidence or facts for each subcategory;

assigning each type of certain pieces of information to a given position in the tree structure;

assigning said positive or negative weighted value to each of said certain pieces of information on the basis of said position in the tree structure.

Preferably said step of determining said reputational rating of any of said natural or legal persons comprises calculating polynomial formulae with coefficients taken from configuration tables, said coefficients being said weighting values of the evidence or facts, and variables given by number of occurrences of the evidence or facts and time factor.

According to another aspect of the present invention it is provided a method for the determination of the reputational rating of natural or legal persons, comprising the following steps:

populating a database with certain pieces of information relating to said natural or legal persons, said certain pieces of information being pertinent to prove evidence or facts object of the evaluation of the reputational rating,

assigning a positive or negative weighted value to each of said certain pieces of information, proportional to a suitability factor of said evidence or facts to contribute to said determination, on the basis of respective positions of said certain pieces of information in a tree structure in said database;

determining said reputational rating of any of said natural or legal persons by summing up all the contributions derived from the weighted values relating to said natural or legal persons.

According to a further aspect of the present invention it is provided a method for the determination of the reputational rating of natural or legal persons, comprising the following steps:

populating a database with certain pieces of information relating to said natural or legal persons, said certain pieces of information being pertinent to prove evidence or facts object of the evaluation of the reputational rating,

assigning a positive or negative weighted value to each of said certain pieces of information, proportional to a suitability factor of said evidence or facts to contribute to said determination, on the basis of respective positions of said certain pieces of information in a tree structure in said database;

determining said reputational rating of any of said natural or legal persons by summing up all the contributions derived from the weighted values relating to said natural or legal persons, and depending on number of occurrences of the evidence or facts in said database and time factor.

Preferably assigning a positive or negative weighted value to each of said certain pieces of information comprises:

deriving metadata from said certain pieces of information, said metadata comprising data relating to the specific type of the instances and the values of enumerated attributes of each certain piece of information,

assigning numerical values to said metadata;

obtaining said positive or negative weighted value on the basis of said metadata.

According to a still further aspect of the present invention it is provided a hardware system suitable for the implementation of the method of the invention.

### BRIEF DESCRIPTION OF THE DRAWINGS

For a better understanding of the invention, examples of embodiments of the invention are described in the following, which shall be considered only as non-limiting examples, in connection with the attached drawings wherein:

FIGS. 1 to 37 show activity flow charts defined through action diagrams of the steps of the method for the determination of the reputational rating of natural and legal persons subject of the invention;

FIGS. 38 to 56 show the logic structures of the data model about the reputational profile defined through composition of class diagrams relating to the method for the determination of the reputational rating of natural and legal persons subject of the invention;

FIG. 57 shows an exemplary embodiment of the system of the present invention.

### DETAILED DESCRIPTION OF THE PREFERRED EMBODIMENTS

In the following exemplary non-limiting examples of embodiments of the system and method of the invention are described, with reference to different kinds of features of the same.

### Basic Principles.

In the following a general description is given of the basic principles underlying the method for the determination of the reputational rating of natural and legal persons, subject of the invention.

The basic principles start from the determination of a “Universal Code for Reputation” (UCR), hereinafter summarized with the following considerations.

All natural and legal persons come into existence with a neutral reputation. All the actions they perform or do not perform and behavior they demonstrate or do not demonstrate, take or do not take, in the course of their lives contribute to their reputation, which is defining from time to time, in a measurable way, as a positive or negative reputation.

All natural and legal persons have the right to protect their own reputation, and have the right to know the reputation of third parties in order to protect themselves from moral or material damages that may result from the relationship with such third parties.

All natural and legal persons therefore have the right to social security of transactions that they are engaged in and the effectiveness of that right is much more protected by a system of accreditation of the reputation which complies with principles of objectivity, transparency, widespread public scrutiny.

Each piece of information, provided it is suitably documented, can be used for building up the reputation. The information must be documented in a written or image form, objectively proving that an action has been actually accomplished or not. In this exercise each one has the right and duty to participate, when a benefit derives to the community, through the use of documented information.

The actions, omissions and significant conducts accomplished by natural and legal persons have a positive impact on the respective reputation if they lead to physical, social, cultural or economic benefits to one or more subjects.

On the contrary, the actions, omissions and significant behaviors performed by natural and legal persons have a negative effect on the respective reputation if they result in physical, social, cultural or economic harm to one or more subjects.

The reiteration of a given act, omission, conduct by a natural or legal person has an effect proportional to the weight it will have for the purpose of reputation building.

The amount of time elapsed since the completion of an act, omission, conduct by a natural or legal person has an effect which is inversely proportional to the weight they will have for the purpose of reputation building.

### General Rules for the Determination of the Reputational Rating.

In the following the general rules for the determination of the reputational rating according to the method of the invention are described.

### 1. The UCR (Universal Code for Reputation) Provides a Structured Reputational Rating.

The structured reputation rating provides for subdivisions into: types of persons, for each type of person a number of categories of facts, for each category a number of subcategories, for each subcategory a number of classes.

The structure provides for the following kinds of subjects:
INDIVIDUALS
PRIVATE LEGAL PERSONS
PUBLIC LEGAL PERSONS

### 2. Individuals

Reputational rating consists of five Categories, all consisting of “facts” of life:

The First is indicative of criminal reputation (relating to possible crimes committed).

The Second is indicative of the fiscal reputation (relative to any outstanding tax and/or social security funds and assistance dispute).

The Third is indicative of the civil reputation (relating to possible civil disputes).

The Fourth is indicative of the reputation for studies and training.

The Fifth is indicative of job reputation, including any civic engagement activities (e.g., volunteering, no profit).

The first, second and third Categories are each represented by a letter from A to Z, where A is the best and Z the worst reputation.

The fourth and fifth Category are represented by two numbers from 0 to 100 where 0 is the worst reputation and 100 is the best.

Then, the reputational rating of the entire humanity (individuals) goes from Z.Z.Z.0.0. (Worst reputation) to A.A.A.100.100. (Best reputation).

To determine these ratings, all the facts of each Category is assigned a value. This value is identified by giving a value to each elementary fact which is then weighted according to:
type of act that proves the fact
pertaining SUBCATEGORY
any other characterizations of fact.

This way a proportionality is determined between the events/actions that constitute the essence of the reputational rating.

Among the various possible characterizations also the passage of time has its incidence, so that a fact is given a higher value if more recent and a lower value if it is older. For the purpose of making homogeneous over time the values calculated for the facts giving rise to fines or other sentences in civil disputes, the same penalties/sums are indexed using as a weight the GDP (Gross Domestic product) of the year when the very fact has materialized.

Similarly, in order to making homogeneous among the various countries the values for the facts giving rise to fines or other sentences in the same penalties/sums are indexed using as a weight the country's relative GDP.

### 2.1. Criminal Reputation Category—Individuals

Subcategories of Facts—Crimes:
Crimes against the person
Crimes against the State
Crimes against the Public Administration
Crimes against property
Crimes against public faith

Each of the above five Subcategories (representative of facts prohibited by the rules of a criminal nature) is assigned a weight proportional to the negative value defined by the UCR.

Each of these five Subcategories is divided into five Classes of imprisonment and fines, each of which is assigned a value.

All of the five Subcategories are related to types of acts, each of which is assigned a weight proportional to the suitability of the Act itself to establish the facts of a particular Subcategory.

The accessory Acts (print and video) (Attachments) are divided into two types of Acts (Attachments), according to their diffusion (national or local) and refer to five Classes of the penalty, in which case the value attributed to these accessory Acts (Attachments) is inversely proportional to the value of the sentence.

The discharging accessory Acts (Attachments) (print and video) are valued with opposite sign to reduce the value achieved.

In the event of recurrence or security measures adopted by order of the court (which require an offense and the permanence of the social dangerousness) will cancel the mitigating effect of the passage of time compared to the offense committed.

All Category CRIMINAL REPUTATION apply the reduction related to the passage of time, which, however, vanishes in case of reiteration (recidivism) or security measures or prevention.

### 2.2. Fiscal Reputation Category—Individuals

Each tax and contribution pendency is divided into five subcategories of value to each of which a value is assigned.

All five value subcategories are related to types of acts, each of which is assigned a weight proportional to the suitability of the Act itself to establish the facts.

The accessory Acts (Attachments) (print and video) are divided into two types of Acts (Attachment), according to their diffusion (national or local) and refer to five Classes of disputes, in which case the value attributed to these accessory Acts (Attachments) is inversely proportional to the value of the tax pendency.

The discharging accessory Acts (print and video) (Attachments) are valued because they go with the opposite sign to reduce the value achieved.

All Category FISCAL REPUTATION apply the reduction related to the passage of time, which, however, vanishes in case of reiteration (recidivism) or security measures or prevention.

### 2.3. Civil Reputation Category—Individuals

Subcategories of Facts—Disputes:
Family
Working
Other breaches of contract
Extra-contractual damages
Succession

For each of the above five Subcategories (representative of facts-disputes) is assigned a weight proportional to the negative value defined by the UCR.

Each of these five Subcategories is divided into five classes of disputes value to each of which is assigned a value.

All of the five Subcategories are related to types of acts, each of which is assigned a weight proportional to the suitability of the Act to establish the facts of a particular SUBCATEGORY.

The accessory Acts (print and video) (Attachments) are divided into two types of Acts (Attachments), according to their diffusion (national or local) and refer to five Classes of disputes, in which case the value attributed to these accessory Acts (Attachments) is inversely proportional to the value of the dispute.

The discharging accessory Acts (Attachments) (print and video) are valued because they go with the opposite sign to reduce the value achieved.

All Category CIVIL REPUTATION apply the reduction related to the passage of time.

### 2.4. Education Reputation Category—Individuals

The Category is segmented into various qualifications: graduation from primary school to PhD, to the post-university qualifications.

Only the earned title is significant and not the possible attendance to the course to which the qualification refers.

Any qualification is assigned a weight that takes into account the importance of the title.

In addition, the weights are attributed in particular taking into account the time required for the attainment of the qualifications.

The result, however, is weighed in a different way depending on the various types of qualification, in four classes:
No difference in terms of result (included in this class diplomas in primary school, lower secondary school and professional qualification)
Maximum ratio between the maximum and minimum marks obtained (included in this class the bachelor's level, degree or unified)
Intermediate ratio between maximum and minimum marks obtained (belong to this class upper secondary school and PhD)
Minimum ratio between maximum and minimum marks obtained (in this class graduate schools) Honor gives additional points.

A certification of the knowledge of each additional language to the mother tongue increases by a percentage of the total value of Education and Training Category.

A certification of the completion of a extra-curricular or extra-university diploma gives a score for each year of the course of study.

The certificate testifying the attainment of a license in accordance with the law gives a score.

The references of teachers are assigned a score that varies according to their number.

The value of RATING so identified is increased by a percentage proportionate to the course of studies (according to the principle “the more he studied the more improved”).

The predicted percentage increase is related to CRIMINAL RATING in the sense that the more it gets worse the more decreased the incidence of this percentage decreases.

### 2.5. Job Reputation Category—Individuals

Subcategories Facts and Work:
Employment
Professional work
Entrepreneurial work
Family Management (home)
Civil commitment.

Classes of facts evaluated for the establishment of the RATING:
age of work beginning: the age at which The first work began generates a value inversely proportional to age of the person;
duration of the working career: each year of employment gives a score that is weighted differently depending on the type of work done;
particular enablements closely related to the exercise of the work and which do not require a compulsory training and/or the achievement of a particular educational qualification;
ownership of patents and/or other intellectual property rights: a score is given based for each patent/right; a reduction applies related to the passage of time.
scientific publications: a score is given based on the number of publications: a reduction applies related to the passage of time.
printed articles and/or TV/Radio/Web services; a score is given based on the number of articles, distinguished on the basis of national or local character: a reduction applies related to the passage of time.
Praise: a score is given based on the kind of the Administration assigning it and the number of praises received; a reduction applies related to the passage of time
Awards/Bonuses: a score is given based on the nature of the entity giving it and the number of awards/bonuses received; a reduction applies related to the passage of time

For the SUBCATEGORY EMPLOYMENT:
Mobility (average duration in months of employment in relation to the duration of his career); a score is given based on length of experience;

a reduction applies related to the passage of time.
References of colleagues: a score is given based on the number of references; a reduction applies related to the passage of time.
References of functional and/or hierarchical superior; a score is assigned based on the number of references; a reduction applies related to the passage of time.
References of users (e.g. students with respect to a professor); a score is assigned based on the number of references; a reduction applies related to the passage of time.

For the SUBCATEGORY OF PROFESSIONAL ACTIVITY AND BUSINESSMAN
Average turnover of last three years; a score is assigned proportional to the turnover;
Client References; a score is given based on the number of references; a reduction applies related to the passage of time.
References of suppliers: a score is given based on the number of references; a reduction applies related to the passage of time.

For the SUBCATEGORY PROFESSIONAL WORK
Annual certification of Professional Credits; a score is given for the annual certification.

For the SUBCATEGORY FAMILY MANAGEMENT
Number of household members; a score is given based on the number of components;
Elapsed time (working career in the position of Family Manager); a score is assigned based on the time spent.

For the SUBCATEGORY CIVIL COMMITMENT
Awards for Civil Valor; a score is given based on the kind of the Administration giving it and the number of awards received; a reduction applies related to the passage of time;
Volunteer activities; a fixed score is given; a reduction applies related to the passage of time

### 3. Private Legal Persons

REPUTATIONAL RATING consists of four CATEGORIES, all consisting of “facts”:

The First indicative of criminal reputation (relating to possible offenses committed);

The Second, indicative of the tax and contributions reputation (relative to any outstanding tax and/or social security funds and assistance);

The Third, indicative of the civil reputation (relating to possible civil disputes)

The Fourth, indicative of the job reputation.

The First three Categories are each represented by a letter from A to Z, where A is the best and Z the worst reputation.

The fourth Category is represented by a number from 0 to 1000 where 0 is the worst reputation and 1000 is the best.

Then, the reputational RATING of the entire Category of private legal entities ranges from Z.Z.Z.0. (Worst reputation) to A.A.A.1000. (Best reputation).

To determine these RATINGS, all the facts of each Category is assigned a value. This value is identified by giving a value to each elementary fact which is then weighted according to:
type of act that documents the fact
pertaining SUBCATEGORY
any other characterizations of the fact.

A proportionality is determined among the events/actions that constitute the essence of the RATING.

Among the various possible characterizations also the passage of time is important, in that given a fact, a higher value is assigned if it is more recent and less if it is older.

For the purpose of homogenizing in the time the values for the facts that provide for fines or sums of civil disputes, the same penalties/sums are indexed using weight as the GDP of the year when the very fact has materialized.

Similarly, in order to homogenize among the various countries the values for the facts that provide for fines or sums of civil disputes, the same penalties/sums are indexed using as a weight the relating country's GDP.

### 3.1. Criminal Reputation Category—Private Legal Persons

Subcategories of Facts-Crimes:
Offences against the Public Administration
Offences against property

For each of the above two Subcategories (representative of facts prohibited by the criminal law) a weight is assigned proportional to the negative value defined by the UCR.

Each of these two Subcategories is divided into five classes of financial penalties and two classes of disqualifications each of which is assigned a value.

The two Subcategories are related to types of acts, each of which is assigned a weight proportional to the suitability of the Act to establish the facts of a particular SUBCATEGORY.

The accessory Acts (Attachments)(print and video) are divided into two types of Acts, according to their diffusion (national or local) and refer to the five Classes of penalties and the two Classes of disqualification, in which case the value attributed to these accessory Acts (Attachments) is inversely proportional to the value of the penalty.

The accessory Acts (Attachments)(print and video) to discharge are valued with contrary sign because they reduce the value achieved.

In the event of recurrence and/or prohibitive measures (which require the commission of an offense and the permanence of the social dangerousness) the mitigating effect of the passage of time is canceled compared to the offense committed.

All Category CRIMINAL REPUTATION is subject to the reduction related to the passage of time, which, however, vanishes in case of recurrence or security measures or prevention.

### 3.2. Fiscal Reputation Category—Private Legal Persons

Each tax and contribution pendency is divided into five classes of value to each of which a value is assigned.

All five value classes are related to types of acts, each of which is assigned a weight proportional to the suitability of the Act to establish the facts.

The accessory Acts (Attachments)(print and video) are divided into two types of Acts (Attachments), according to their diffusion (national or local) and refer to five Classes of disputes, in which case the value attributed to these accessory Acts (Attachments) is inversely proportional to the value of the tax pendency.

The accessory Acts (Attachments) (print and video) to discharge are valued with the opposite sign to reduce the value achieved.

All Category FISCAL REPUTATION is subject to the reduction related to the passage of time, which, however, vanishes in case of recurrence or security measures or prevention.

### 3.3. Civil Reputation Category—Private Legal Persons

Subcategories of Facts—Disputes:
Working
Other breaches of contract
Extra-contractual damages

For each of the above three Subcategories (representative of facts-disputes) a weight is assigned proportional to the negative value defined by the UCR.

Each of these three Subcategories is divided into five classes of values of disputes to each of which is assigned a value.

The three Subcategories are related to types of acts, each of which is assigned a weight proportional to the suitability of the Act to establish the facts of a particular SUBCATEGORY.

The accessory Acts (Attachments)(print and video) are divided into two types of Acts (Attachments), according to their diffusion (national or local) and refer to five Classes of disputes, in which case the value attributed to these Acts is inversely proportional to the value of the dispute.

The accessory Acts (Attachments)(print and video) to discharge are valued with the opposite sign to reduce the value achieved.

All Category CIVIL REPUTATION is subject to the reduction related to the passage of time, which, however, vanishes in case of recurrence or security measures or prevention.

### 3.4. Job Reputation Category—Private Legal Persons

### Subcategories of Work—Facts:

Work activity
Civil commitment

Classes of facts evaluated for the establishment of the RATING:
duration of the activity: a score is given for each year of activity.
mandatory qualifications closely related to the exercise of the activity (e.g. security clearance): a score is given for each qualification.
Ownership of patents and/or other intellectual property rights: a score is given for each patent/right.
Optional certification (e.g. ISO 9000, SA 8000, etc.): a score is given for each certification.
Printing articles and/or TV/Radio/Web contributions: a score is given based on the number of articles relating to the person concerned, distinguishing if they are at national or local level.
Average turnover last three year: a score is given proportional to the turnover.
Praises: a score is given based on the nature of the Body giving them and the number of citations received.
Awards: a score is given based on the nature of the Body giving them and the number of awards received.

For the SUBCATEGORY CIVIL COMMITMENT
Awards for Civil Valor: a score is given based on the nature of the Body giving them and the number of awards received.
Volunteer activities ongoing: a fixed score is given

### 4. Public Legal Persons

REPUTATION RATING consists of four CATEGORIES, all consisting of “facts”:

The First indicative of criminal reputation (relating to possible offenses committed)

The Second, indicative of the fiscal reputation (relative to any outstanding tax and/or social security funds and assistance)

The Third, indicative of the civil reputation (relating to possible civil disputes),

The Fourth, indicative of the job reputation.

The First three Categories are each represented by a letter from A to Z, where A is the best and Z the worst reputation.

The fourth Category is represented by a number from 0 to 1000 where 0 is the worst reputation and 1000 is the best.

Then, the reputational RATING of the entire Category of private legal entities ranging from Z.Z.Z.0. (Worst reputation) to A.A.A.1000. (Best reputation).

To determine these RATING, all the facts of each Category is assigned a value. This value is identified by giving a value to each elementary fact which is then weighted according to:
type of act that documents the fact
pertaining SUBCATEGORY
any other characterizations of fact.

A proportionality is determined between the events/actions that constitute the essence of the RATING.

Among the various possible characterizations also the passage of time has its importance, then the same kind of fact is given a higher value if more recent and less if it is older.

For the purpose of homogenizing time values for the facts that provide for fines or sums of civil disputes, the same penalties/sums are indexed using as a weight the GDP of the year when the very fact has materialized.

Similarly, in order to homogenize the various countries the values for the facts that provide for fines or sums of civil disputes, the same penalties/sums are indexed using as a weight the country's GDP.

### 4.1. Criminal Reputation Category—Public Legal Persons

Subcategories of Facts-Crimes:
Offences against the Public Administration
Offences against property

For each of the above two Subcategories (representative of facts prohibited by the criminal law) a weight is assigned proportional to the negative value defined by the UCR.

Each of these two Subcategories is divided into five classes of financial penalties and two classes of disqualifications, each of which is assigned a value.

Each of the two Subcategories is related to types of acts, each of which is assigned a weight proportional to the suitability of the Act to establish the facts of a particular SUBCATEGORY.

The accessory Acts (Attachments)(print and video) are divided into two types of Acts (Attachments), according to their diffusion (national or local) and refer to the five Classes of penalties and the two Classes of disqualification, in which case the value attributed to these accessory Acts (Attachments) is inversely proportional to the value of the penalty.

The accessory Acts (Attachments) (print and video) to discharge are valued with the opposite sign because they reduce the value achieved.

In the event of recurrence and/or prohibitive measures (which require the commission of an offense and the permanence of the social dangerousness) the mitigating effect of the passage of time is canceled for the offense committed.

All Category CRIMINAL REPUTATION is subject to the reduction related to the passage of time, which, however, vanishes in case of recurrence or security measures or prevention.

### 4.2. Fiscal Reputation Category—Public Legal Persons

Each tax and contribution pendency is divided into five classes of value to each of which a value is assigned.

All five classes of value are related to types of acts, each of which is assigned a weight proportional to the suitability of the Act to establish the facts.

The accessory Acts (Attachments)(print and video) are divided into two types of Acts (Attachments), according to their diffusion (national or local) and refer to five Classes of disputes, in which case the value attributed to these accessory Acts (Attachments) is inversely proportional to the value of the tax pendency.

The accessory Acts (Attachments) (print and video) to discharge are valued with the opposite sign because they reduce the value achieved.

All FISCAL REPUTATION Category is subject to the reduction related to the passage of time, which, however, vanishes in case of recurrence or security measures or prevention.

### 4.3. Civil Reputation Category—Public Legal Persons

Subcategories of Facts—Disputes:
Working
Other breaches of contract
Extra-contractual damages

For each of the above three Subcategories (representative of facts-disputes) a weight is assigned proportional to the negative value defined by the UCR.

Each of these three Subcategories is divided into five value classes of disputes to each of which a value is assigned.

Each of the three Subcategories are related to types of acts, each of which is assigned a weight proportional to the suitability of the Act to establish the facts of a particular SUBCATEGORY.

The accessory Acts (Attachments) (print and video) are divided into two types of Acts (Attachments), according to their diffusion (national or local) and refer to five Classes of disputes, in which case the value attributed to these accessory Acts (Attachments) is inversely proportional to the value of the tax pendency.

The accessory Acts (Attachments) (print and video) to discharge are valued with the opposite sign because they reduce the value achieved.

All CIVIL REPUTATION Category is subject to the reduction related to the passage of time, which, however, vanishes in case of recurrence or security measures or prevention.

### 4.4. Job Reputation Category—Public Legal Persons

Subcategories of Facts—Work:
Working activity
Civil commitment

Some classes of facts have been identified to build the RATING:
Seniority of activity: a score is given for each year of activity;
Ownership of patents and/or other intellectual property rights: a score is given for each patent/right.
Optional certification (eg ISO 9000, SA 8000, etc.): a score is given for each certification.
Printed articles and/or TV/Radio/Web services: score is given based on the number of articles relating to the party concerned, distinguishing if they have a national or local character;
Personnel expenses, average of last three years: a score is given depending on the personnel expenses incurred;
Percentage of administrative costs (for the existence and functioning of the institution) on the total benefits paid calculated as the average of the last three financial years: a score is given for each percentage point;
Praises: a score is given based on the kind of Administration giving them, and the number of citations received;
Awards: a score is given based on the kind of Body giving them, and the number of awards received.

For the SUBCATEGORY of CIVIL COMMITMENT
Awards for Civil Valor: a score is given based on the kind of Administration giving them, and the number of citations received;
Volunteer activities ongoing: a fixed score is given
Occasional volunteer activities: a fixed score is given

Algorithms of the Method

In the following non-limiting examples of the algorithms used in the method of the invention to calculate the reputational rating of a subject are described, by means of flow charts of sequences of steps. The detailed description does not include specific reference to numerals in the drawing figures, as from the following description the skilled in the art, having a look to the interconnection of the blocks in the diagrams, is able to implement software routines carrying out the algorithms, keeping in mind that a possible programming language is the well-known Java. The algorithms examine all the data concerning the reputational profile stored in the data-base of the system.

The data-base containing the data of the subjects covered by the invention is fed with metadata (evidence) derived from and supported by certain pieces of information filed by the parties interested to promote surveys of reputation, documented in favor of themselves or in favor or against third parties. Everything is in accordance with the above defined UCR. The metadata (evidence) and supporting certain pieces of information (documents) are inserted in the data-base by the interested parties by means of web applications connecting to the server of the hardware system described below.

In particular the metadata comprise data relating to the specific type of the instance and the values of enumerated attributes of each of the certain piece of information,

Basically the algorithm calculates polynomial formulae with coefficients taken from configuration tables, the coefficients being the specific weighting values of the evidence or facts, and variables given by number of occurrences of the evidence or facts and time factor. The configuration tables are indexed by keeping into account the position of the facts and evidence in the tree structure above described of categories, subcategories, classes.

The following explanation of the algorithms comprises:
activity flows defined through activity diagrams;
data model about the reputational profile, defined through class diagrams.

### 5. Activity Diagrams

### 5.1. Algorithm Diagram

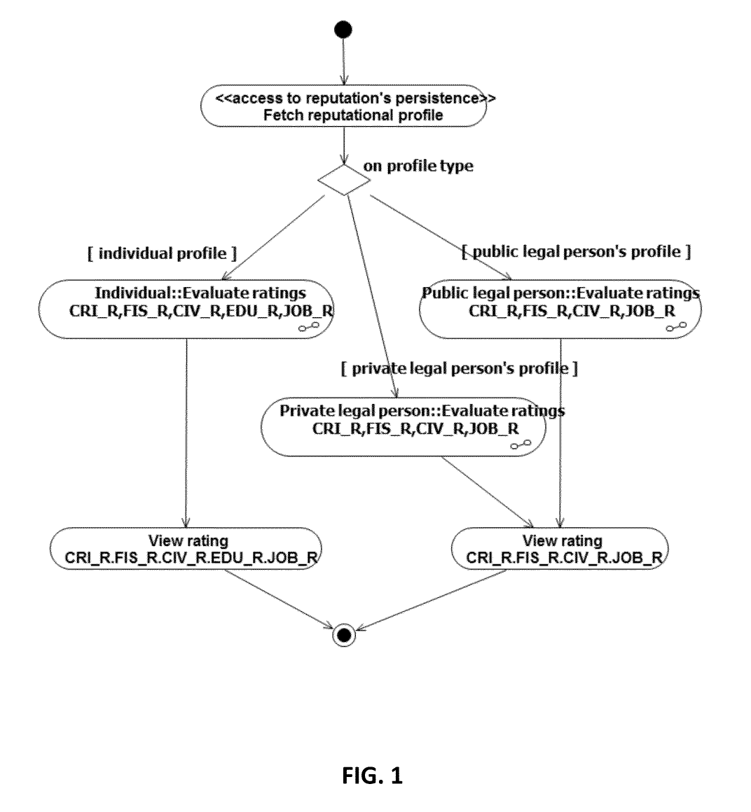

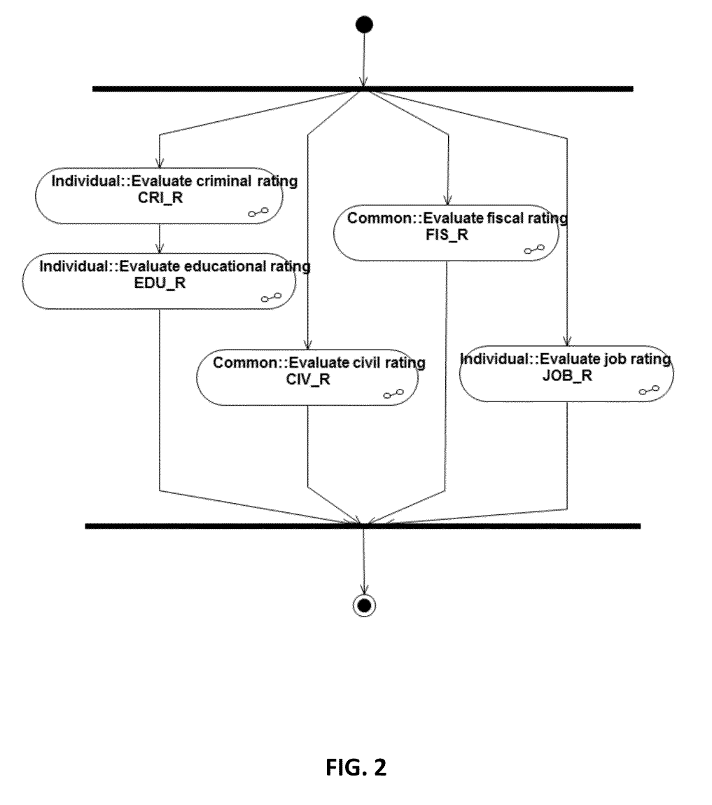

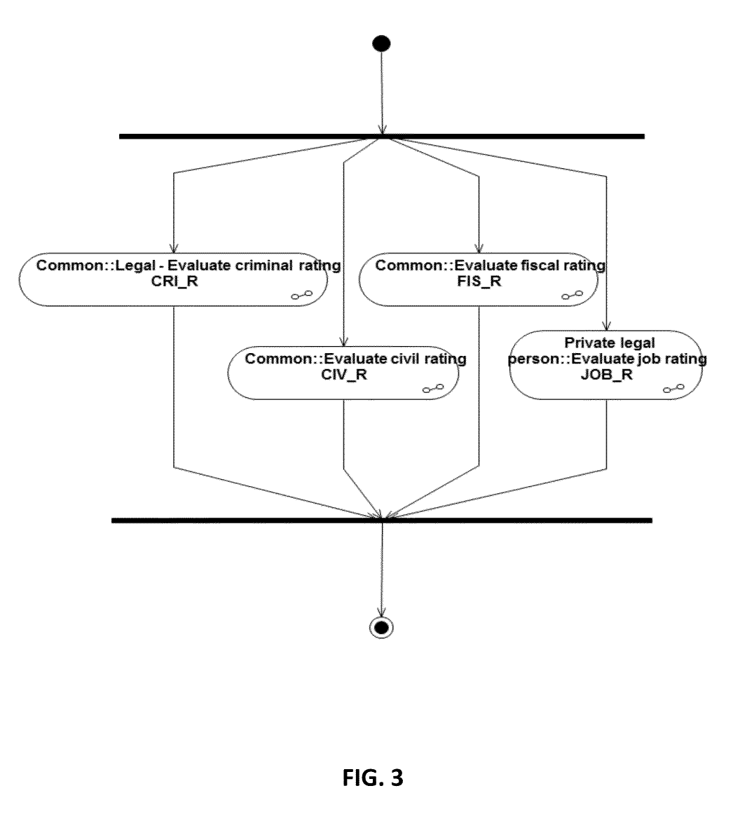

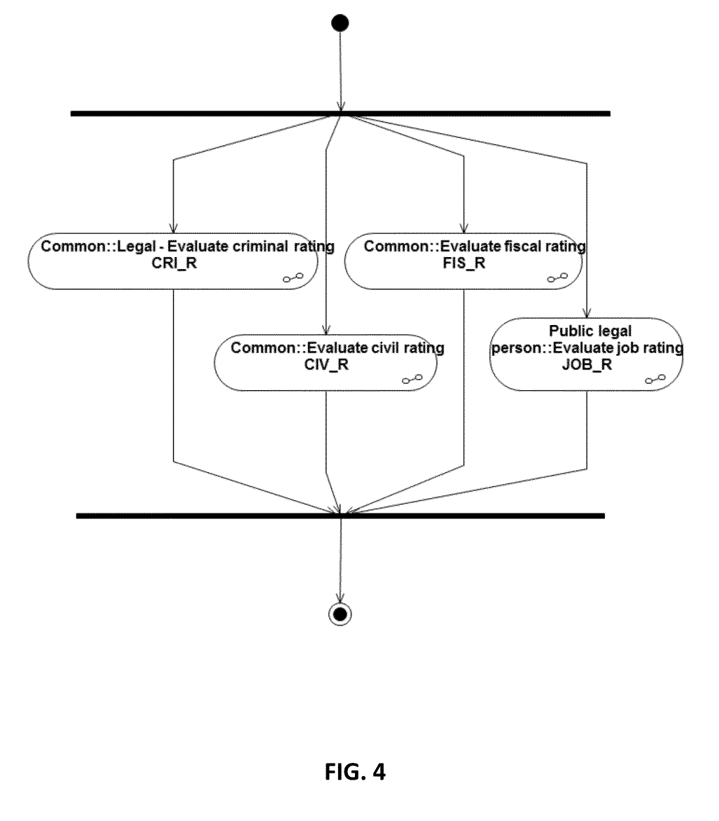

With reference to FIGS. 1 to 4 the main flow chart that determines the URC rating algorithm of the invention is described. In particular FIG. 1 is a general overview diagram, FIG. 2 relates to the evaluation rating of an individual, FIG. 3 relates to the evaluation rating of a private legal person, FIG. 4 relates to the evaluation rating of a public legal person.

The reputational rating (Universal Code for Reputation—UCR) is structured in three ways, related to the type of the subject:
INDIVIDUALS;
PRIVATE LEGAL PERSONS (companies, private institutions, . . . );
PUBLIC LEGAL PERSONS (public institutions, . . . ).

UCR of INDIVIDUALS is composed by 5 parts:
criminal reputation (related to crimes or special preventive measures);
fiscal reputation (related to fiscal disputes);
civil reputation (related to civil disputes);
education;
job reputation.

UCR of LEGAL PERSONS, PRIVATE or PUBLIC, is composed by 4 parts:
criminal reputation (related to crimes or special preventive measures);
fiscal reputation (related to fiscal disputes);
civil reputation (related to civil disputes);
job reputation.

UCR is evaluated through the facts and their supporting evidence that compose the reputational profile, excluding suspended ones (i.e. a fact may be suspended because there is a related discrepancy pending).

In all the following diagrams are used the stereotypes below:
<<access to reputation's persistence>>:

it means that the activity performs a database access;
<<read algorithm's configuration>>:

it means that the activity reads the coefficient related to a specific category of facts, from a configuration table or matrix;
<<read reputation's properties>>:

it means that the activity fetches information from the reputational profile (according to the data model defined in the class diagrams).

### Notes

The notes below are valid for all the diagrams.
The amounts of money (revenues, financial penalties, . . . ) must be measured in normalized working days, defined with the formula:

working_days=(amount*365/GDP per capita)

where GDP per capita=daily gross domestic product per capita related to the year during which the amount was defined.
The time factor concerning the age of a fact, is applied through a multiplicative coefficient (TF) read from the table below, indexed by the age

| Range of years | TF |
|---|---|
| m1, M1 | TF1 |
| m2, M2 | TF2 |
| m3, M3 | TF3 |

### 5.2. Evaluate Category of Items Diagram

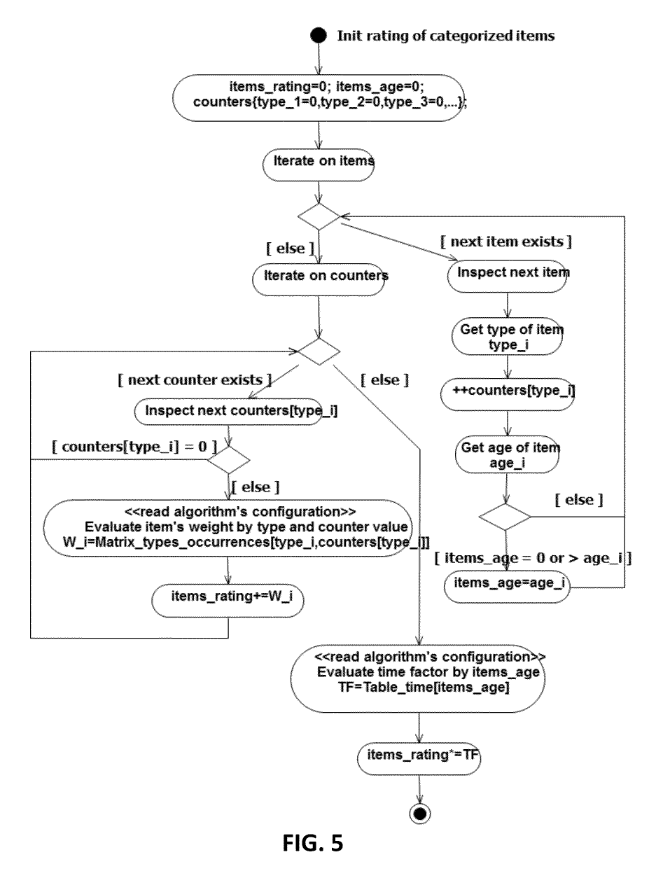

FIG. 5 show a flow chart with a general scope, which determines a subflow of activities to be included in other charts. It defines the rating contribution of set of facts with a specific category, considering their types (subcategories), the number of occurrences for each type (distributed in ranges) and the age of the facts.

The matrix below with types and occurrences (Matrix_types_occurrences) defines the coefficient W related to a fact.

number of occurrences

| Fact | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |

The time factor is applied at the end of the flow, as a global factor evaluated on the age of the most recent fact (criterion of continuity).

### 5.3. Evaluate Civil Rating Diagram

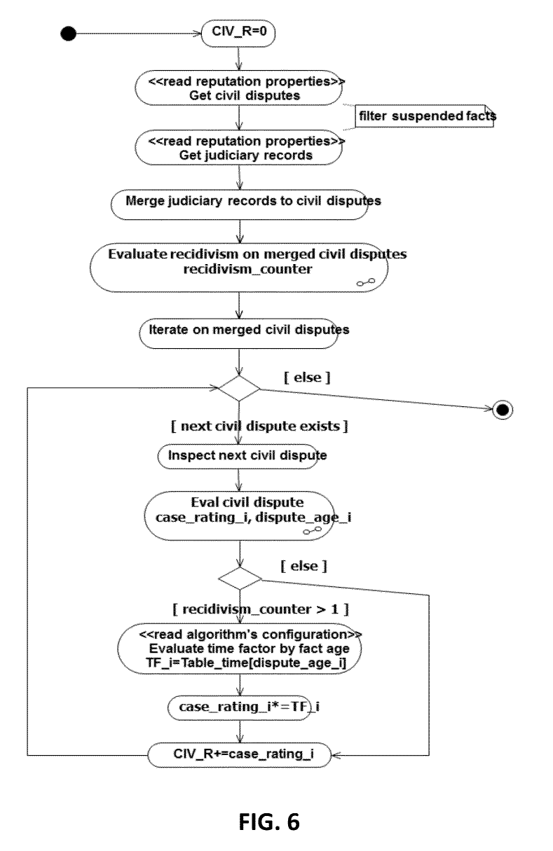

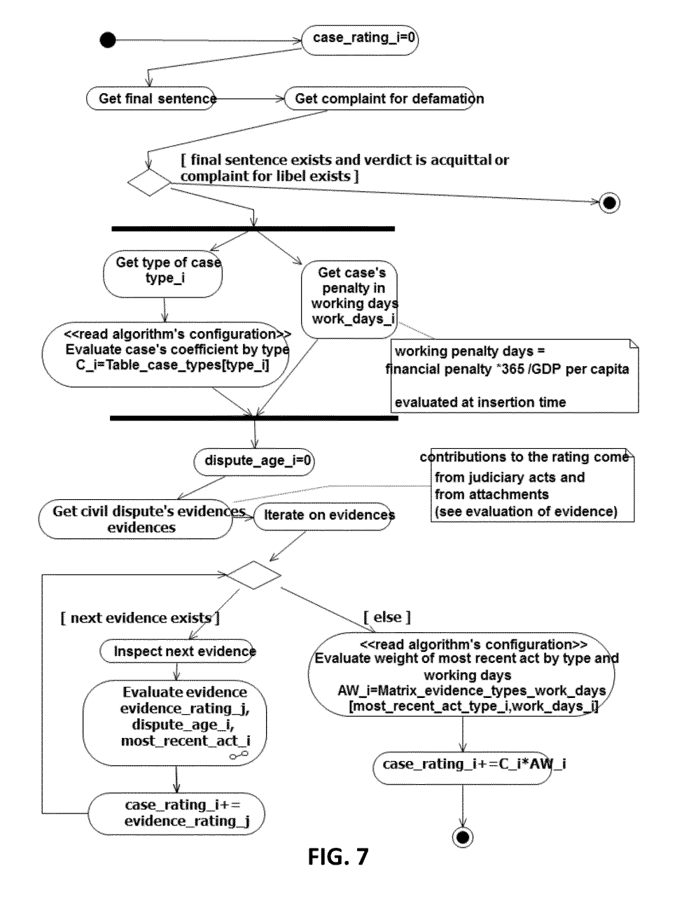

FIGS. 6, 7, 10, 11 show flow charts of actions for determining the civil rating (CIV_R) of individual and legal person (private or public).

This rating is based on the weights assigned to the facts (valid, not suspended) fetched from the civil disputes published through the surveys against a third party and from the items of the judiciary records published through the surveys pro oneself.

The rating is calculated iterating on the evidence of all the facts defined above.

Recidivism happens when there is more than one dispute (recidivism_counter>1).

Each dispute contributes to the rating with the most recent judicial act and all the related attachments (videos, articles, . . . )

The time factor is applied only if recidivism doesn't happen and is based on the age of the fact.

Considering a dispute and the related type, the coefficient C is defined through the table of types (Table_cases_types) below

| Type of dispute | Coefficient |
|---|---|
| type 1 | C1 |
| type 2 | C2 |
| type 3 | C3 |

Finally, the weight AW of each evidence is evaluated considering the types and the penalty amount measured in working days, through the matrix types/working days (Matrix_evidence_types_work_days) below

Ranges of working days

| Evidence | m1-M1 | m2-M2 | m3-M3 | . . . |
|---|---|---|---|---|
| type 1 | AW11 | AW12 | AW13 | . . . |
| type 2 | AW21 | AW22 | AW23 | . . . |
| type 3 | AW31 | AW32 | AW33 | . . . |

### 5.4. Evaluate Fiscal Rating Diagram

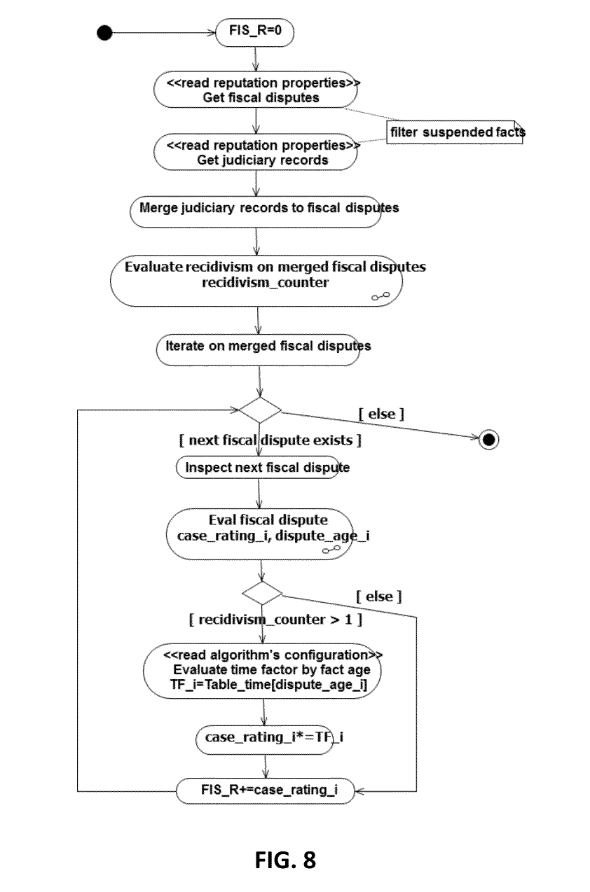

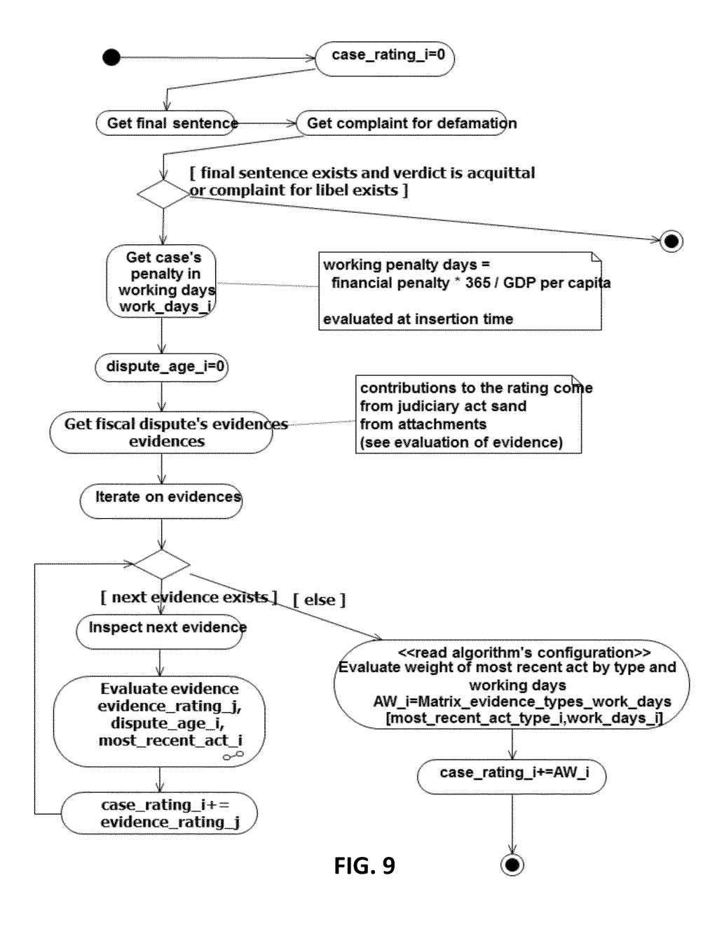

FIGS. 8, 9, 10, 11 show flow charts of actions for determining the fiscal rating (FIS_R) of individual and legal person (private or public).

This rating is based on the weights assigned to the facts (valid, not suspended) fetched from the fiscal disputes published through the surveys against a third party and from the items of the judiciary records published through the surveys pro oneself.

The rating is calculated iterating on the evidence of all the facts defined above.

Recidivism happens when there is more than one dispute (recidivism_counter>1).

Each dispute contributes to the rating with the most recent judicial act and all the related attachments (videos, articles, . . . )

The time factor is applied only if recidivism doesn't happen and is based on the age of the fact.

For each dispute, the weight AW of each evidence is evaluated considering the types and the penalty amount measured in working days, through the matrix types/working days (Matrix_evidence_types_work_days) below

Ranges of working days

| Evidence | m1-M1 | m2-M2 | m3-M3 | . . . |
|---|---|---|---|---|
| type 1 | AW11 | AW12 | AW13 | . . . |
| type 2 | AW21 | AW22 | AW23 | . . . |
| type 3 | AW31 | AW32 | AW33 | . . . |

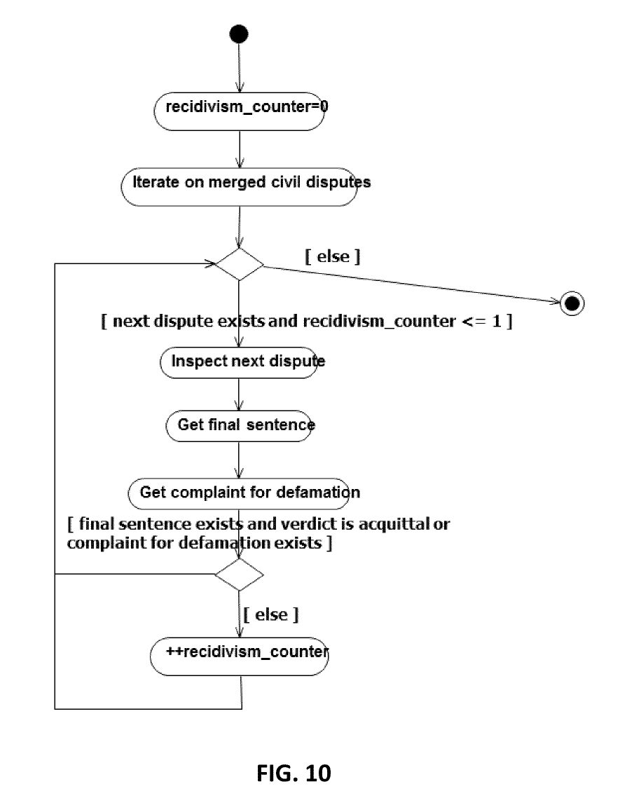

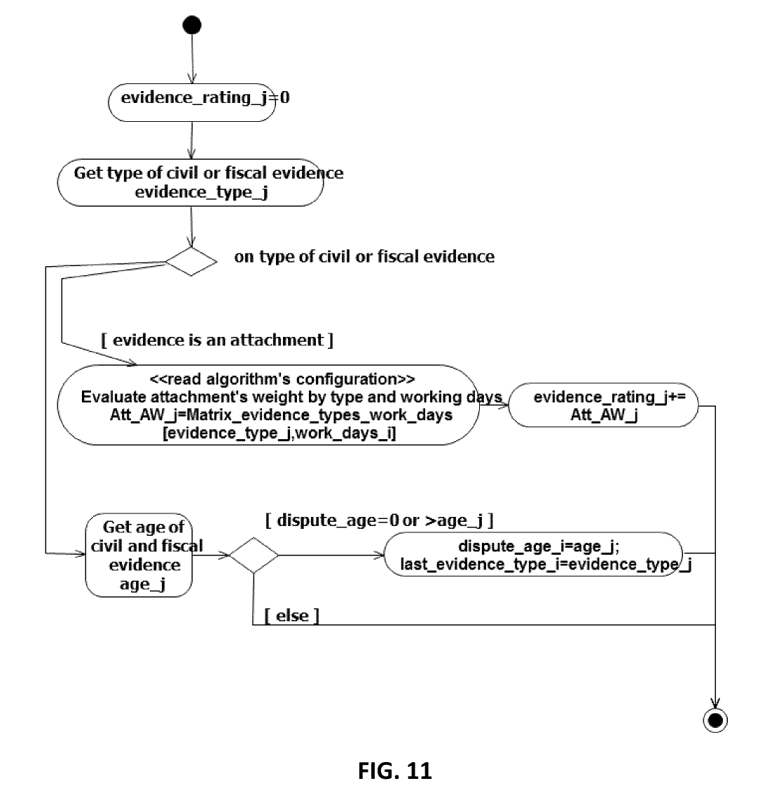

It is to be noted that the procedure shown in the flow charts of FIGS. 10 and 11, relating to respectively evaluating recidivism and dispute's evidence can apply to both Evaluate civil rating and Evaluate fiscal rating.

### 5.5. Evaluate Job Rating—Evaluate Civil Activities Diagram

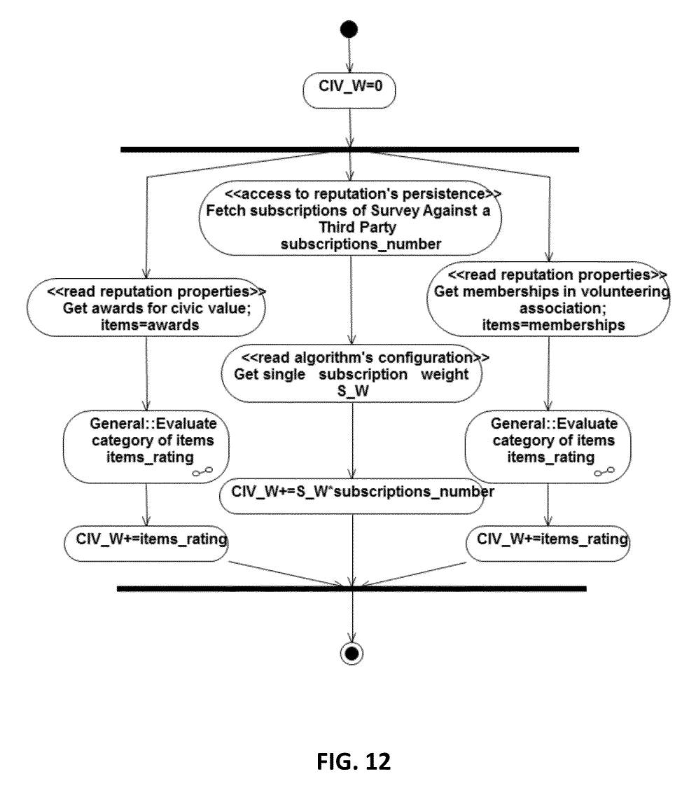

FIG. 12 shows a flow chart of actions for determining the rating (CIV_W) related to the civil and social activities of individual and legal person (private or public).

This rating is evaluated as the sum of contributions related to awards for civic value, memberships in volunteering association and the number of subscriptions to the surveys of Mevaluate (each one multiplied by a coefficient S_W).

### 5.6. Legal Person—Evaluate Criminal Rating Diagram

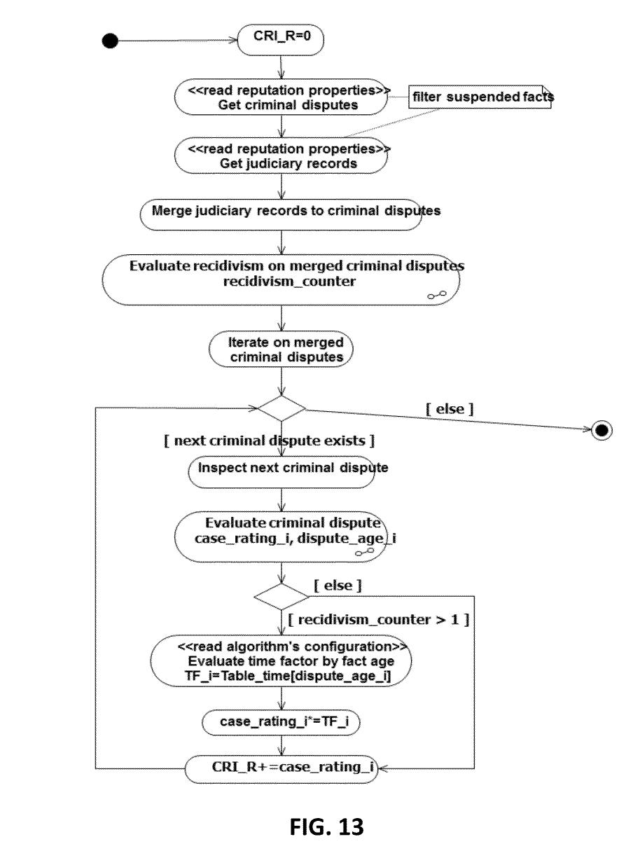

FIGS. 13, 14, 15, 16 show flow charts of actions for determining the criminal rating (CRI_R) of a legal person (private or public).

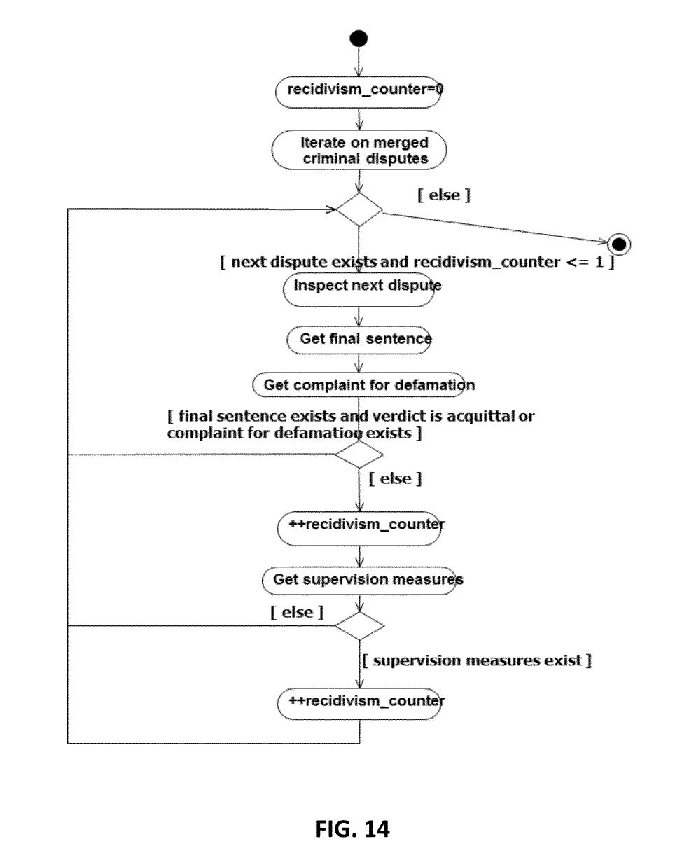

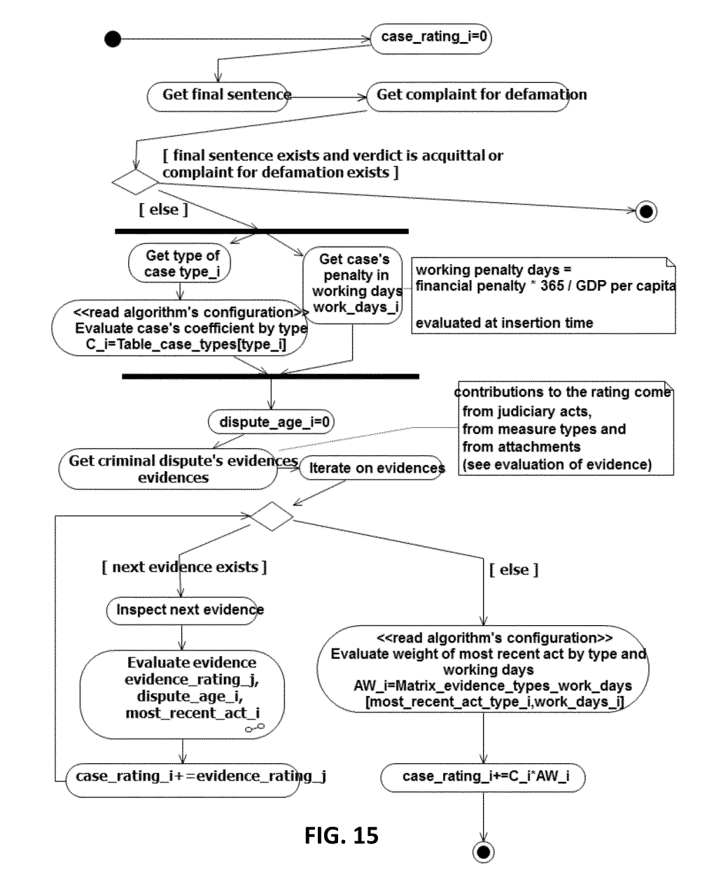

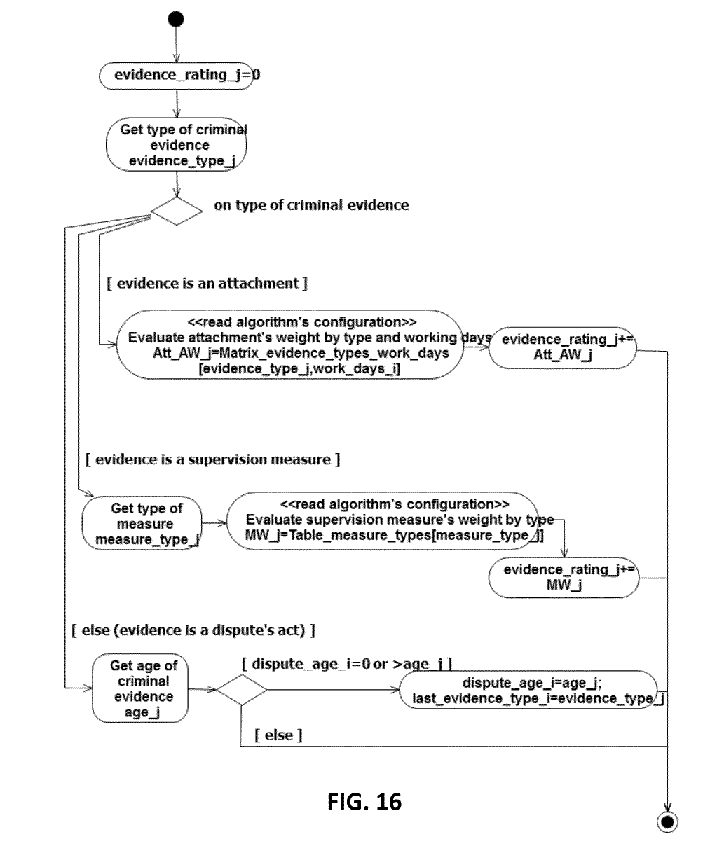

In particular FIG. 13 relates to a general overview diagram of the procedure, FIG. 14 relates to the evaluation of the recidivism, FIG. 15 relates to the evaluation of disputes, FIG. 16 relates to the evaluation of dispute's evidence.

This flow chart defines the criminal rating (CRI_R) of a legal person (private or public).

This rating is based on the weights assigned to the facts (valid, not suspended) fetched from the criminal disputes and the special preventive measures published through the surveys against a third party and from the items of the judiciary records published through the surveys pro oneself.

The rating is calculated iterating on the evidence of all the facts defined above.

Recidivism happens when there is more than one dispute or if there is just one supervision measure (recidivism_counter>1).

Each dispute contributes to the rating with the most recent judicial act and all the related attachments (videos, articles, . . . )

The time factor is applied only if recidivism doesn't happen and is based on the age of the fact.

Considering a dispute and the related type, the coefficient C is defined through the table of types (Table_cases_types) below

| Types of case | Coefficient |
|---|---|
| type 1 | C1 |
| type 2 | C2 |
| type 3 | C3 |

For each evidence not related to a supervision measure, the weight AW is evaluated considering the types and the penalty amount measured in working days, through the matrix types/working days (Matrix_evidence_types_work_days) below

ranges of working days

| Evidence | m1-M1 | m2-M2 | m3-M3 | . . . |
|---|---|---|---|---|
| type 1 | AW11 | AW12 | AW13 | |
| type 2 | AW21 | AW22 | AW23 | |
| type 3 | AW31 | AW32 | AW33 | |

For each evidence related to a supervision measure, the MW weight is evaluated through the table of the supervision measures' types (Table_measure_types) below

| Type of supervision measure | MW |
|---|---|
| type 1 | MW1 |
| type 2 | MW2 |
| type 3 | MW3 |

### 5.7. Legal Person—Evaluate Job Rating—Evaluate Intellectual Properties Diagram

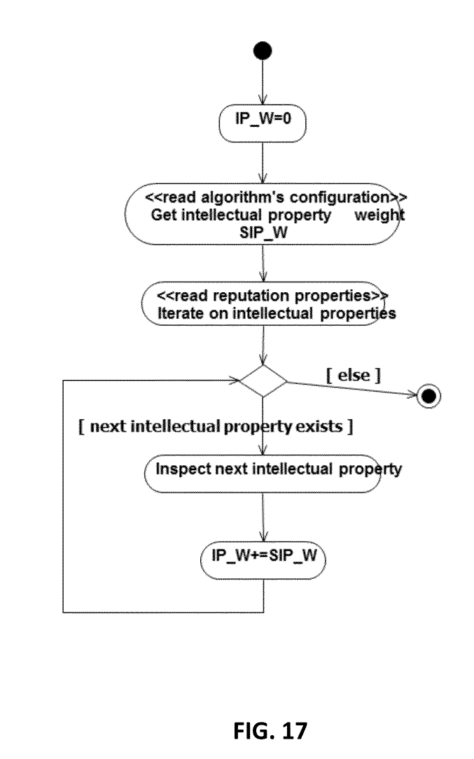

FIG. 17 shows a flow chart of actions for determining the rating (IP_W) related to the intellectual properties of a legal person (private or public).

For each intellectual property, it's added the coefficient SIP_W.

### 5.8. Individual—Evaluate Criminal Rating Diagram

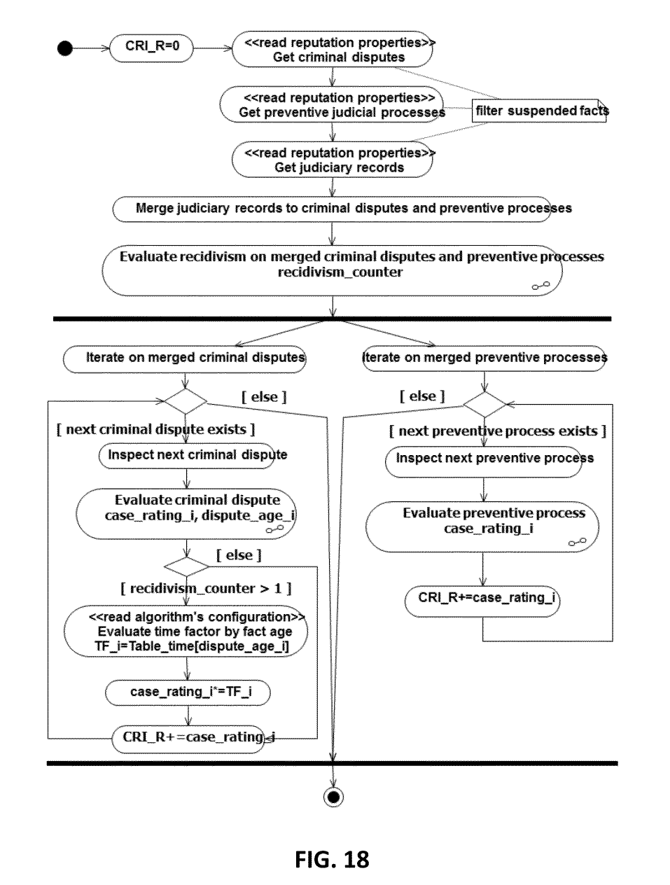

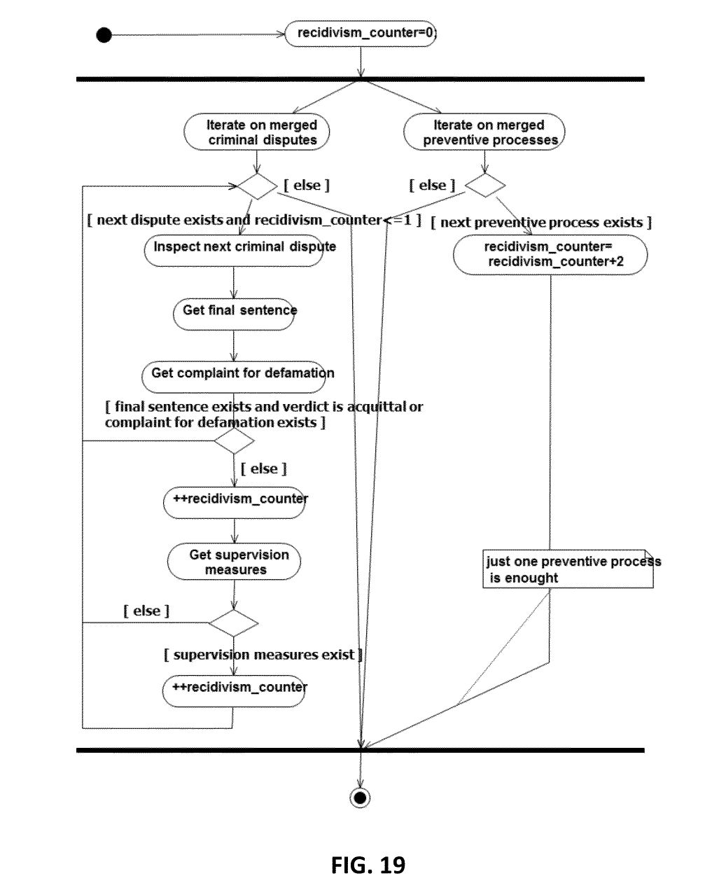

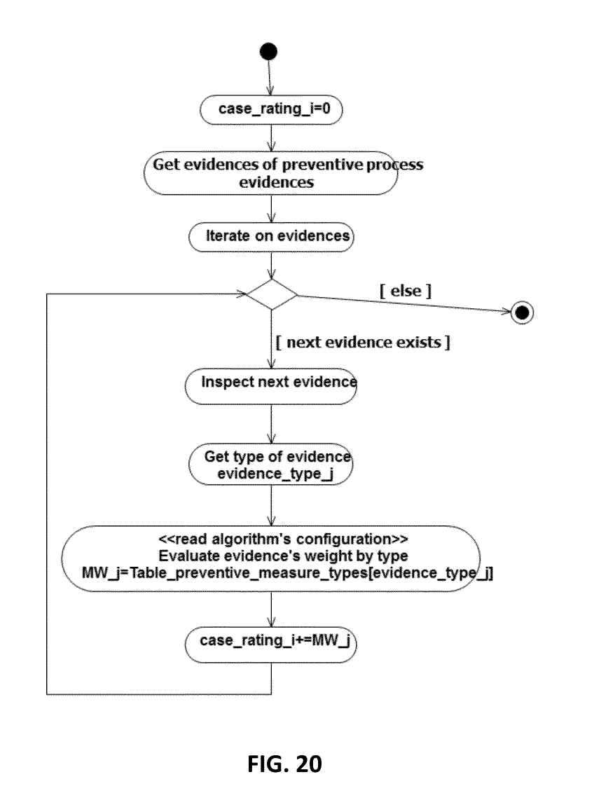

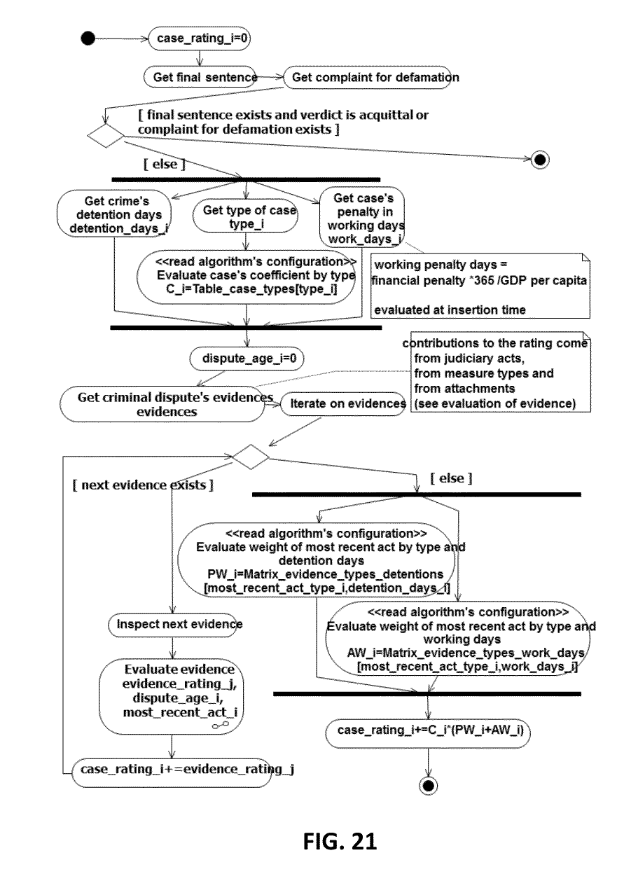

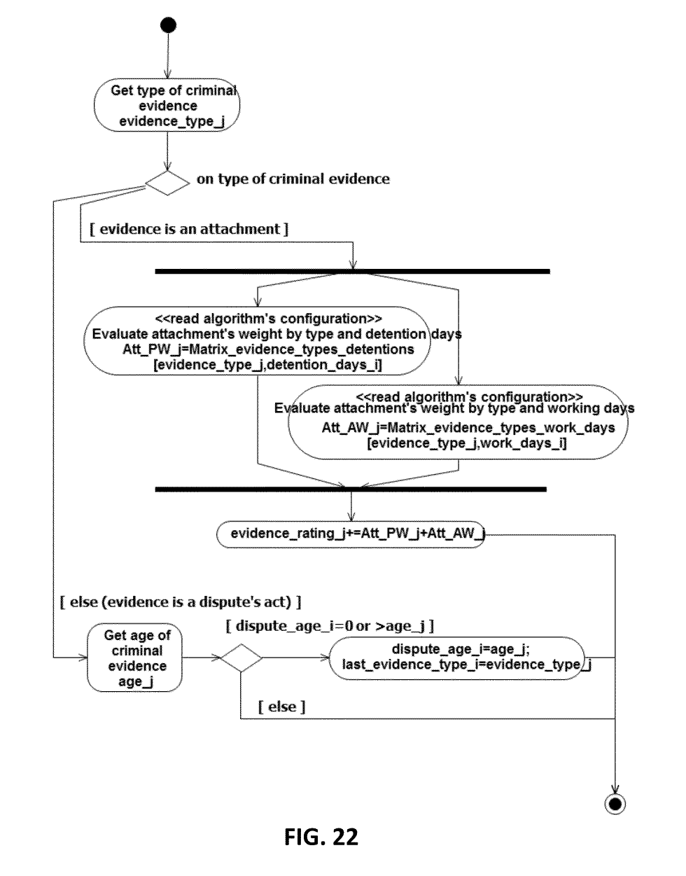

FIGS. 18, 19, 20, 21, 22 show flow charts of actions for determining the criminal rating (CRI_R) of individuals. In particular FIG. 18 relates to a general overview diagram of the procedure, FIG. 19 relates to the evaluation of the recidivism, FIG. 20 relates to the evaluation of the preventive process, FIG. 21 relates to the evaluation of disputes, FIG. 22 relates to the evaluation of dispute's evidence.

This rating is based on the weights assigned to the facts (valid, not suspended) fetched from the criminal disputes and the special preventive measures published through the surveys against a third party and from the items of the judiciary records published through the surveys pro oneself.

The rating is calculated iterating on the evidence of all the facts defined above.

Recidivism happens when there is more than one dispute or if there is just one special preventive measure or supervision measure (recidivism_counter>1).

Each dispute contributes to the rating with the most recent judicial act and all the related attachments (videos, articles, . . . )

The time factor is applied only if recidivism doesn't happen and is based on the age of the fact.

Considering a dispute and the related type, the coefficient C is defined through the table of types (Table_cases_types) below

| Types of case | Coefficient |
|---|---|
| type 1 | C1 |
| type 2 | C2 |
| type 3 | C3 |

For each evidence of a dispute, two weights are considered: the PW weight based on the detention days and the AW weight based on the financial penalty.

The weight PW is evaluated through the matrix types/detention days (Matrix_evidence_types_tentions) below

Ranges of detention days

| Types of evidence | m1-M1 | m2-M2 | m3-M3 . . . |
|---|---|---|---|
| type 1 | PW11 | PW12 | PW13 |
| type 2 | PW21 | PW22 | PW23 |
| type 3 | PW31 | PW32 | PW33 |

The weight AW is evaluated considering the types and the penalty amount measured in working days, through the matrix types/working days (Matrix_evidence_types_work_days) below

Ranges of working days

| Types of evidence | m1-M1 | m2-M2 | m3-M3 . . . |
|---|---|---|---|
| type 1 | AW11 | AW12 | AW13 |
| type 2 | AW21 | AW22 | AW23 |
| type 3 | AW31 | AW32 | AW33 |

For each evidence related to a special preventive measure, the MW weight is evaluated through the table of the preventive measures' types (Table_preventive_measure_types) below

| Types of supervision measure | MW |
|---|---|
| type 1 | MW1 |
| type 2 | MW2 |
| type 3 | MW3 |

5.9. Individual—Evaluate educational rating Diagram

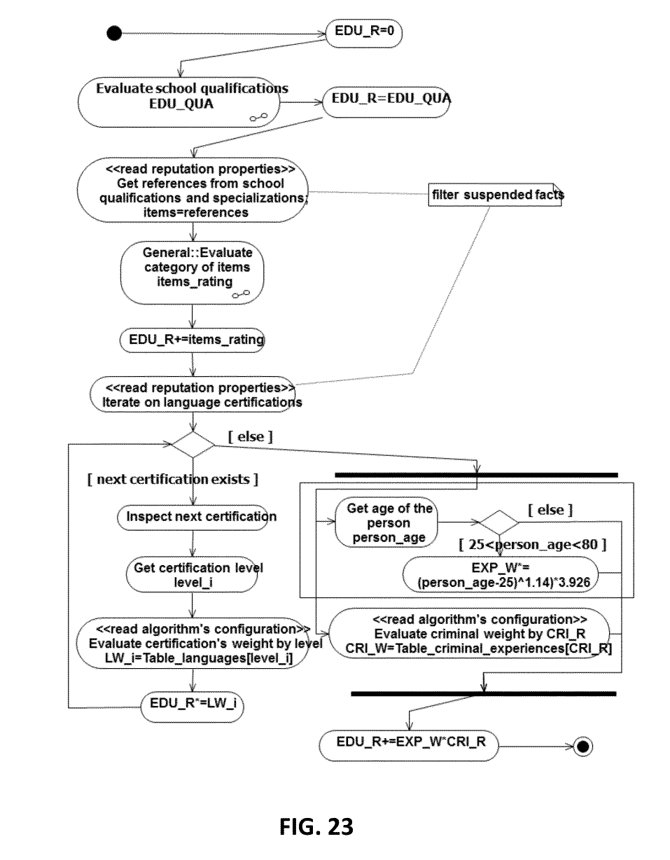

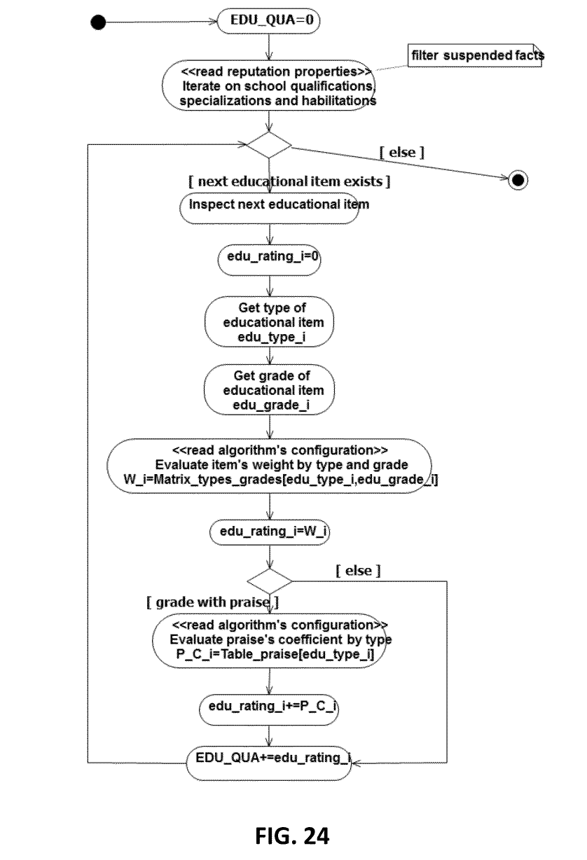

FIGS. 23, 24 show flow charts of actions for determining the rating (EDU_R) related to the education of individuals (school qualification).

This rating is based on the weights assigned to the facts (valid, not suspended) fetched from the list of school qualifications, specializations, habilitations, references written by teachers and language certifications published through the surveys pro oneself.

On this rating the age factor is taken under consideration (the more one grows up, the more percentage of facts he is capable of transforming into life experience), and a negative coefficient related to some socially negative behavior.

The weight W of school qualification (or specialization or habilitation) is evaluated considering the type of qualification and the final grade, through the matrix types/grades (Matrix_types_grades) below

Ranges of grades

| Edu type | g1-G1 | g2-G2 | g3-G3 |
|---|---|---|---|
| type 1 | W11 | W12 | W13 |
| type 2 | W21 | W22 | W23 |
| type 3 | W31 | W32 | W33 |

In case of grade with praise, an additional coefficient P_C is evaluated considering the type of qualification, through the table of praises (Table_praise) below

| Edu type | Coefficient |
|---|---|
| type 1 | P_C1 |
| type 2 | P_C2 |
| type 3 | P_C3 |

The weight LW of a language certification is evaluated considering the certification level, through the table of languages (Table_languages) below

| Level | Weight |
|---|---|
| level 1 | LW1 |
| level 2 | LW2 |
| level 3 | LW3 |

The above defined age factor regarding the improvements of the personal knowledge related to the life's experiences, is applied using the weight EXP_W is evaluated considering the age of the person, through the table of experiences (Table_experiences) below

| Age (ranges) | Weight |
|---|---|
| m1-M1 | EXP_W1 |
| m2-M2 | EXP_W2 |
| m3-M3 | EXP_W3 |

Finally, the incidence of socially negative behaviours is evaluated considering the criminal rating CRI_R, previously calculated, through the table of the criminal history (Table_criminal_experiences) below

| CRI_R (ranges) | Weight |
|---|---|
| m1-M1 | CRI_W1 |
| m2-M2 | CRI_W2 |
| m3-M3 | CRI_W3 |

### 5.10. Individual—Evaluate Job Rating Diagram

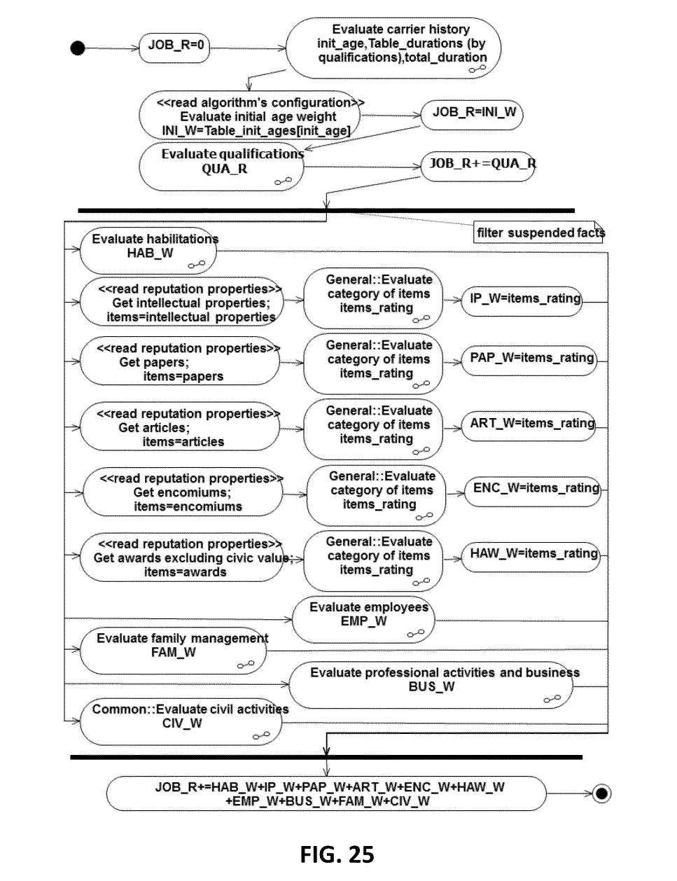

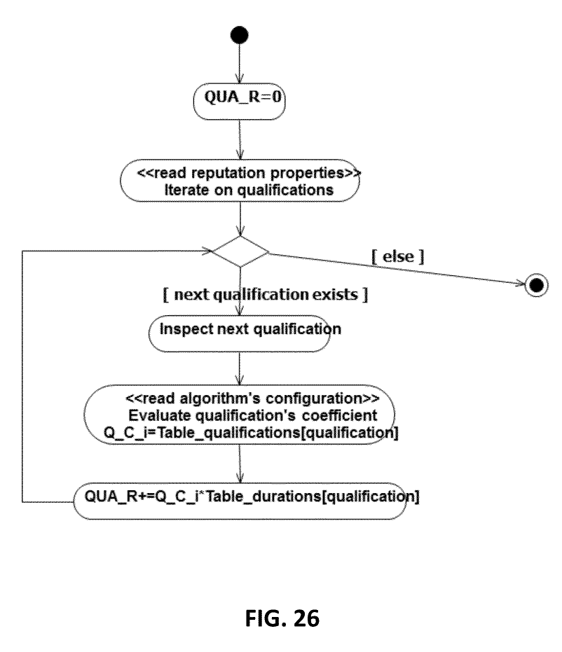

FIGS. 25, 26 show flow charts of actions for determining the job rating (JOB_R) of individuals. In particular FIG. 26 relates to the evaluation of qualifications.

This rating is based on the weights assigned to the facts (valid, not suspended) fetched from the list of job experiences (employees, professional activities, business, family management) with related habilitations, references, awards, encomiums published through the surveys pro oneself.

Also civil activities in volunteering associations are evaluated.

The flow chart starts with the analysis of the carrier history, determining the age of the first experience (init_age), the carrier duration (total_duration) and the durations of experiences with specific qualification (Table_durations is the table of these durations indexed by the qualifications).

The weight INI_W of the first experience is evaluated through the table of initial ages (Table_init_ages) below

| Age (ranges) | Weight |
|---|---|
| m1-M1 | INI_W1 |
| m2-M2 | INI_W2 |
| m3-M3 | INI_W3 |

For each job qualification assumed during the carrier, the related duration is multiplied by a coefficient Q_C evaluated through the table of qualifications (Table_qualifications) below

| Qualification | Coefficient |
|---|---|
| type1 | Q_C1 |
| type2 | Q_C2 |
| type3 | Q_C3 |

Finally, all the contributions of the job experiences listed below are summed (the evaluation of each contribution is defined in a specific diagram):
habilitations;
intellectual properties;
publications;
articles;
encomiums;
awards;
employees;
professional activities and business;
family management;
social experiences (volunteering association).

### 5.11. Individual—Evaluate Job Rating—Evaluate Carrier History Diagram

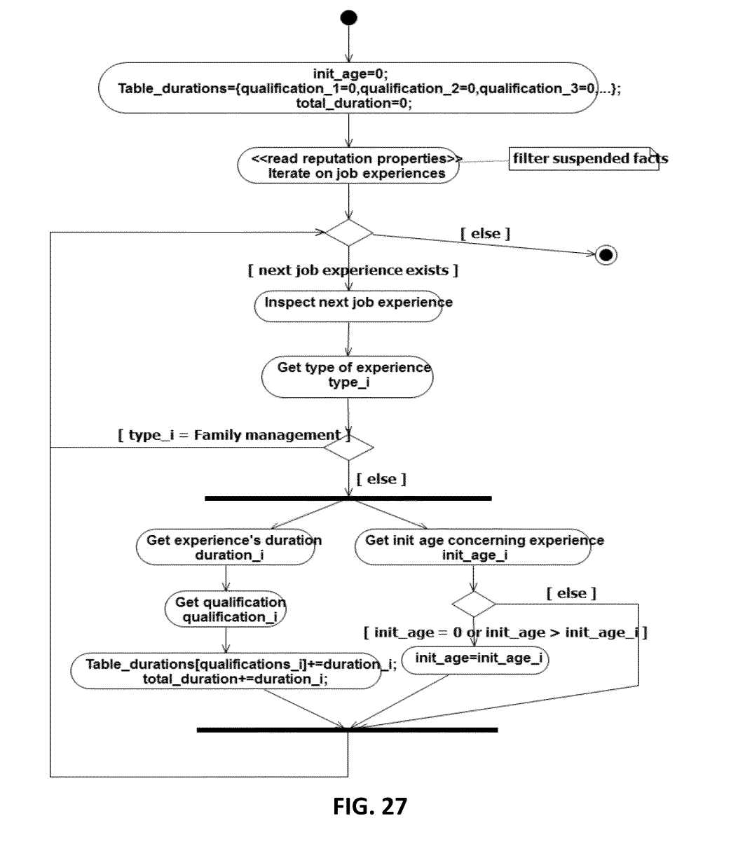

FIG. 27 shows a flow chart of actions for determining the carrier history of individuals.

It determines the age of the first experience (init_age), the carrier duration (total_duration) and the durations of job experiences with specific qualification (Table_durations is the table of these durations indexed by the qualifications).

### 5.12. Individual—Evaluate Job Rating—Evaluate Employees Diagram

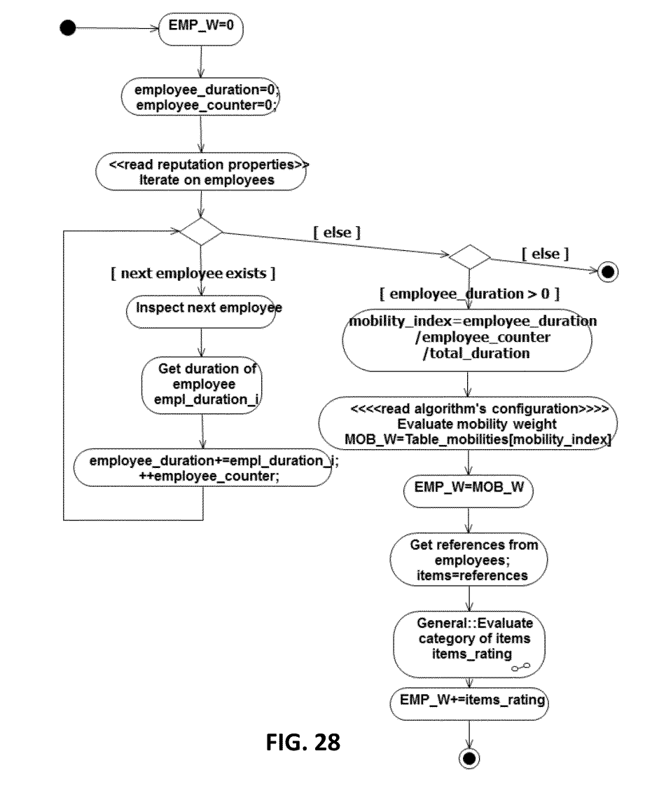

FIG. 28 shows a flow chart of actions for determining the rating (EMP_W) related to employees activities.

All the employees are analyzed to calculate the coefficient of mobility as the average duration divided by the duration of the carrier history. This coefficient is used to evaluate the weight of the mobility MOB_W through the table of mobilities (Table_mobilities) below

| Ranges of mobility values | Weight |
|---|---|
| m1-M1 | MOB_W1 |
| m2-M2 | MOB_W2 |
| m3-M3 | MOB_W3 |

Finally are considered the references related to the job experiences.

### 5.13. Individual—Evaluate Job Rating—Evaluate Family Management Diagram

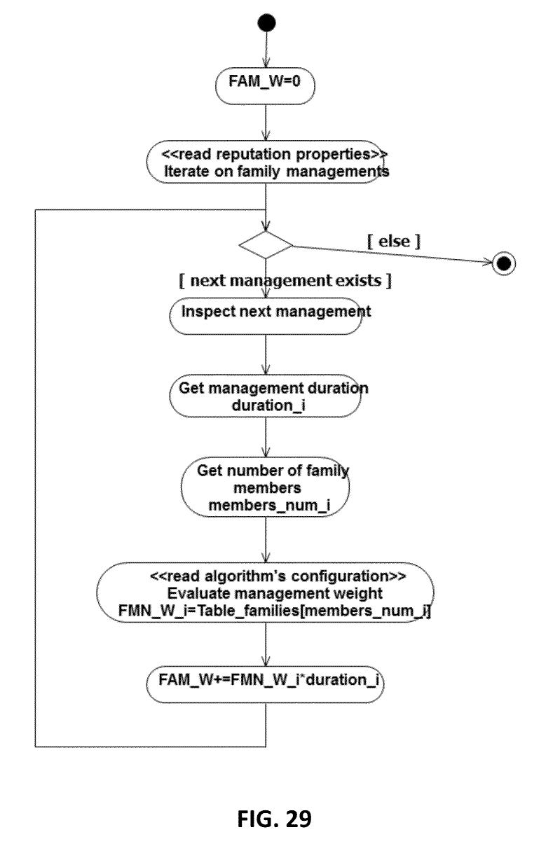

FIG. 29 shows a flow chart of actions for determining the rating (FAM_W) related to activities of family management.

These experiences are analyzed considering the duration and the number of family members; the weight FMN_W related to the family composition is evaluated through the table (Table_families) below

| Number of members | Weight |
|---|---|
| 1 | FMN_W1 |
| 2 | FMN_W2 |
| 3 | FMN_W3 |

### 5.14. Individual—Evaluate Job Rating—Evaluate Habilitations Diagram

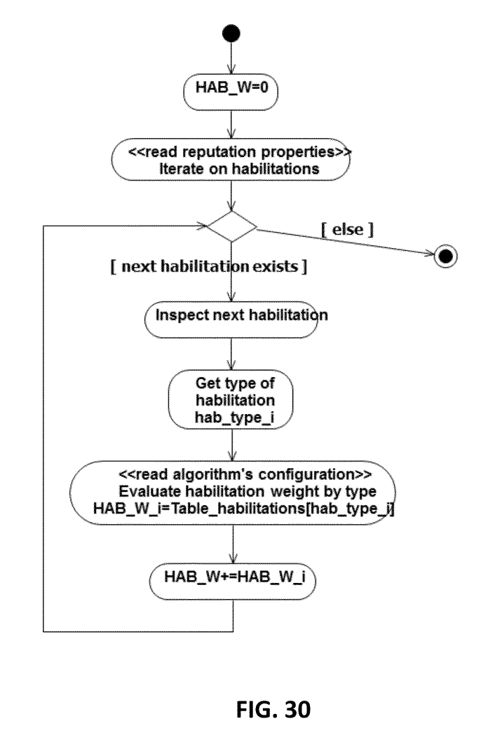

FIG. 30 shows a flow chart of actions for determining the rating related to the habilitations of working activities of individuals.

For each habilitation, the weight HAB_W is evaluated considering the type, through the table (Table_habilitations) below

| Types of habilitation | Weight |
|---|---|
| type1 | HAB_W1 |
| type2 | HAB_W2 |
| type3 | HAB_W3 |

### 5.15. Individual—Evaluate Job Rating—Evaluate Professional Activities and Business Diagram

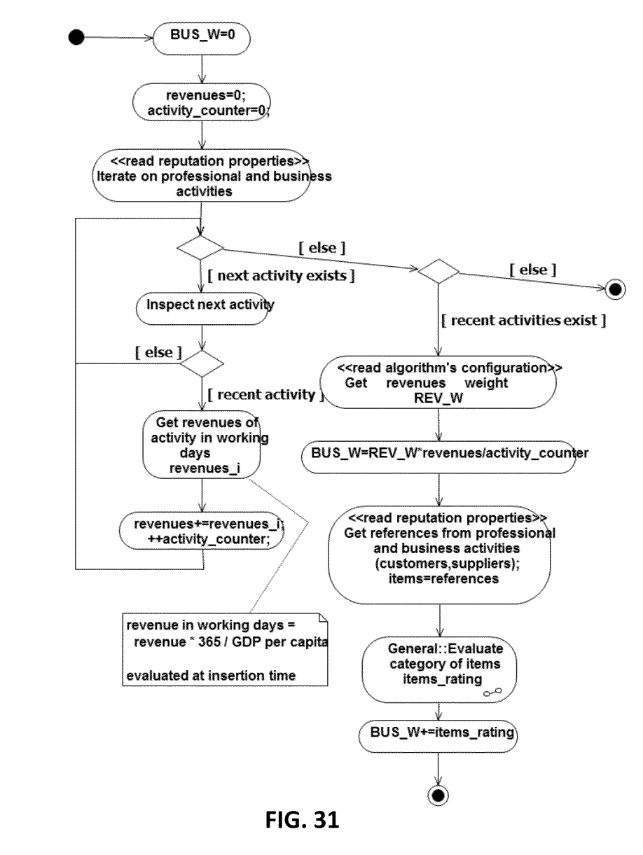

FIG. 31 shows a flow chart of actions for determining the rating (BUS_W) related to professional activities and business of individuals.

All the job experiences are analyzed to calculate the average revenue

This value is multiplied by the coefficient REV_W.

Finally, are added the contributions related to the references about these activities.

### 5.16. Private Legal—Evaluate Job Rating Diagram

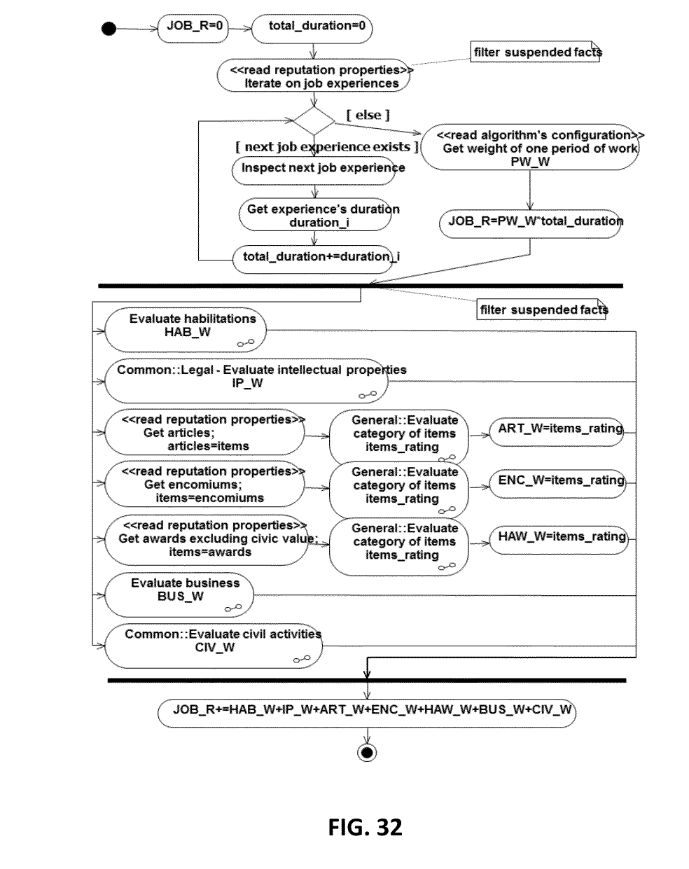

FIG. 32 shows a flow chart of actions for determining the job rating (JOB_R) of a private legal person.

This rating is based on the weights assigned to the facts (valid, not suspended) fetched from the list of job activities with related habilitations, references, awards, encomiums published through the surveys pro oneself.

Also civil activities in volunteering associations are evaluated.

The flow charts starts evaluating the total duration (total_duration) of the carrier. This value is multiplied by the coefficient PW_W.

Finally, all the contributions of the job experiences listed below are summed (the evaluation of each contribution is defined in a specific diagram):
habilitations;
intellectual properties;
articles;
encomiums;
awards;
business;
social experiences (volunteering association).

### 5.17. Private Legal—Evaluate Job Rating—Evaluate Business Diagram

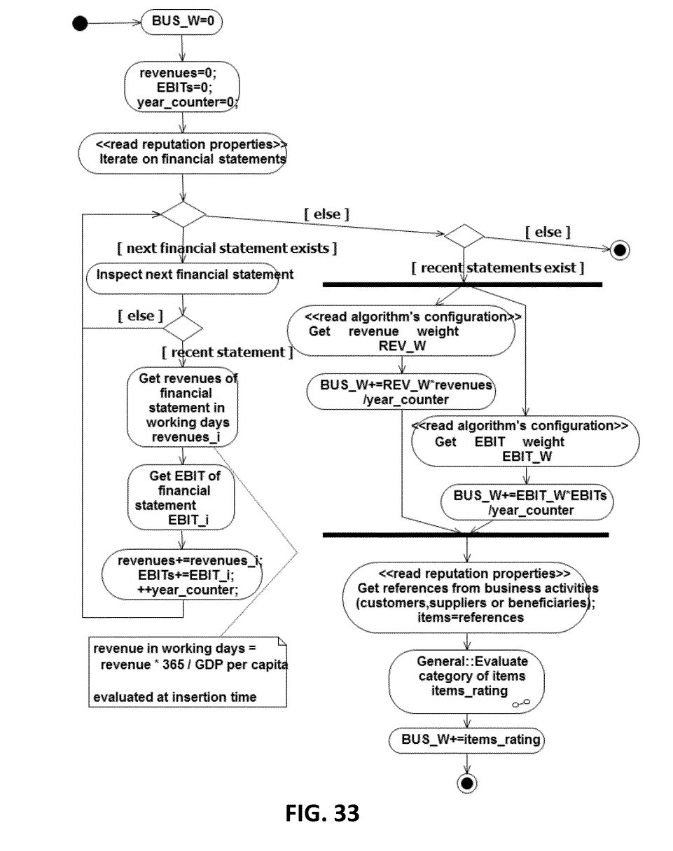

FIG. 33 shows a flow chart of actions for determining the rating (BUS_W) related to the business activities of a private legal person.

The financial statements are analyzed to calculate the average revenue and the average EBIT.

The average revenue is multiplied by the coefficient REV_W and the average EBIT is multiplied by the coefficient EBIT_W.

Finally, are added the contributions related to the references about these activities

### 5.18. Private Legal—Evaluate Job Rating—Evaluate Habilitations Diagram

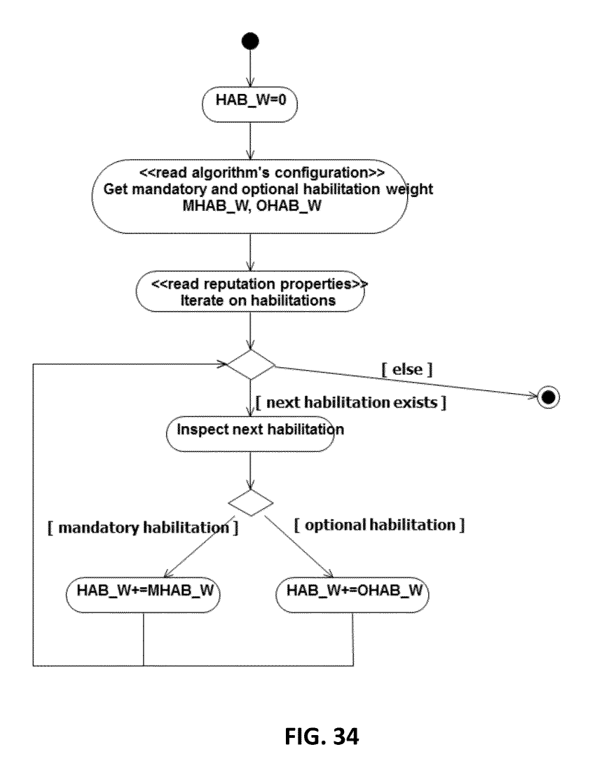

FIG. 34 shows a flow chart of actions for determining the rating related to the habilitations of a private legal person.

For each mandatory habilitation, it's added the coefficient MHAB_W. For each optional habilitation, it's added the coefficient OHAB_W.

### 5.19. Public Legal—Evaluate Job Rating Diagram

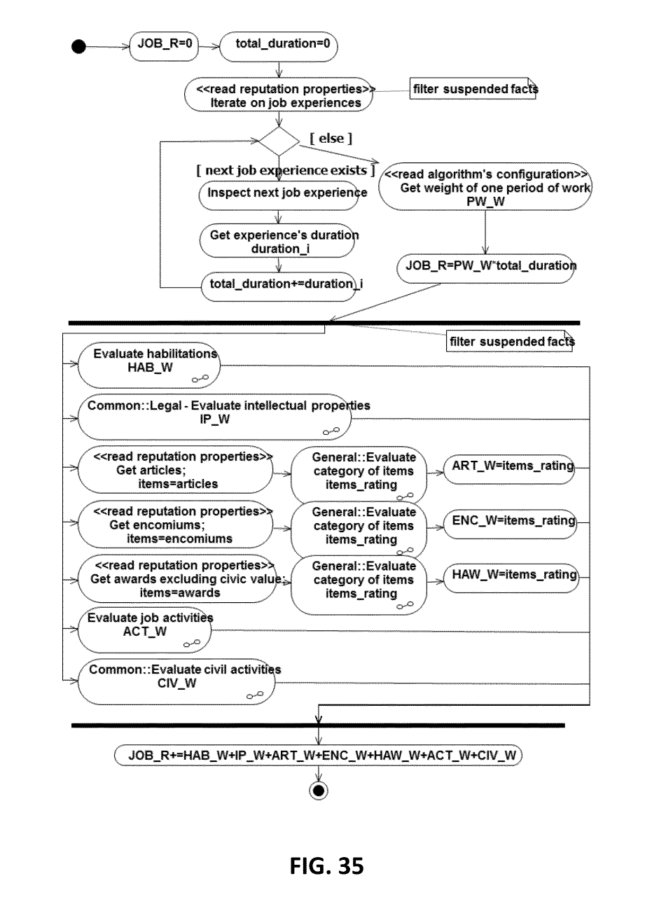

FIG. 35 shows a flow chart of actions for determining the job rating (JOB_R) of a public legal person.

This rating is based on the weights assigned to the facts (valid, not suspended) fetched from the list of job activities with related habilitations, references, awards, encomiums published through the surveys pro oneself.

Also civil activities in volunteering associations are evaluated.

The flow charts starts evaluating the total duration (total_duration) of the carrier. This value is multiplied by the coefficient PW_W.

Finally, all the contributions of the job experiences listed below are summed (the evaluation of each contribution is defined in a specific diagram):
habilitations;
intellectual properties;
articles;
encomiums;
awards;
job activities;
social experiences (volunteering association).

### 5.20. Public Legal—Evaluate Job Rating—Evaluate Activities Diagram

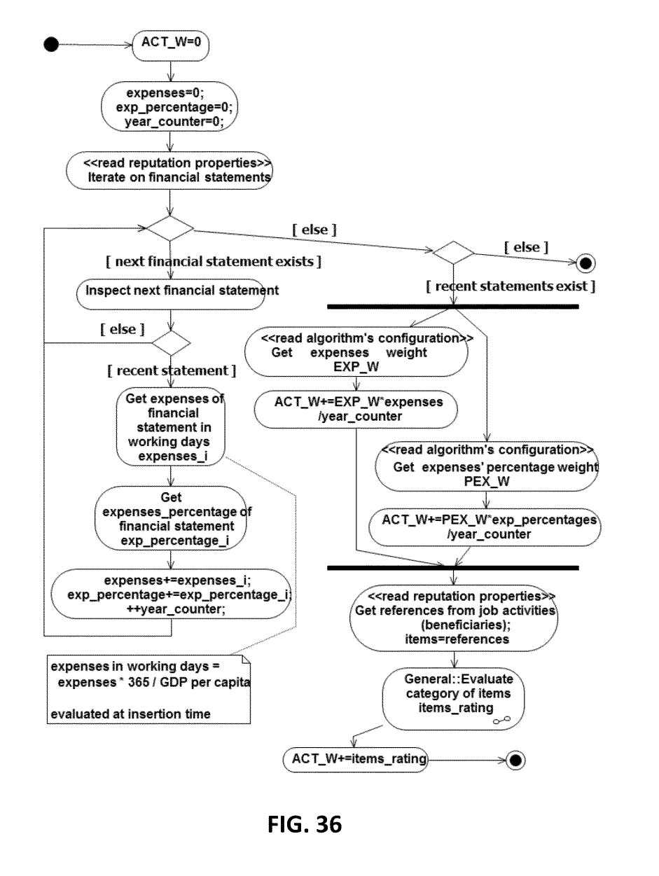

FIG. 36 shows a flow chart of actions for determining the rating (ACT_W) related to the job activities of a public legal person.

The financial statements are analyzed to calculate the average expenses and the average percentage of the expenses divided by the turnover.

The average expenses are multiplied by the coefficient EXP_W and the average percentage is multiplied by the coefficient PEX_W

Finally, are added the contributions related to the references about these activities

### 5.21. Public Legal—Evaluate Job Rating—Evaluate Habilitations Diagram

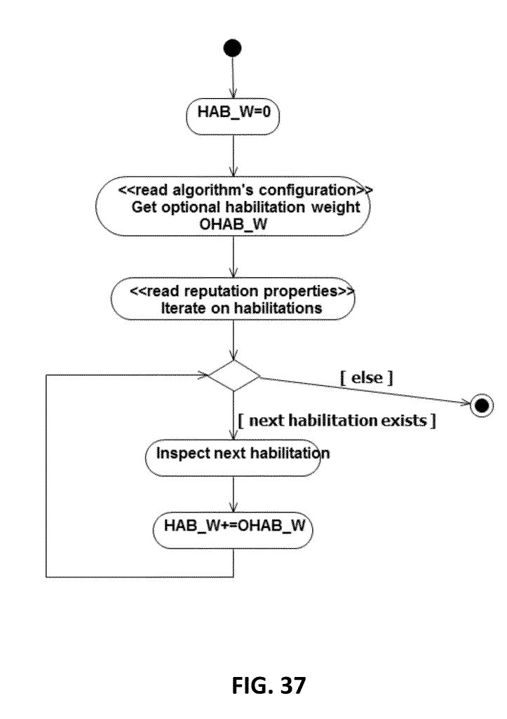

FIG. 37 shows a flow chart of actions for determining the rating related to the habilitations of a public legal person for the working activity.

For each (optional) habilitation, it's added the coefficient OHAB_W.

### 6. Class Diagrams

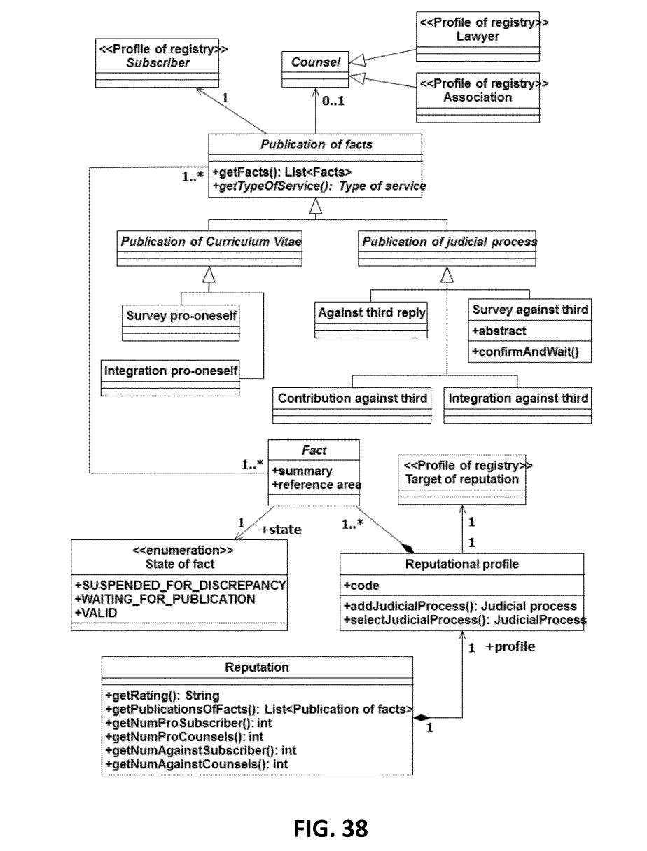

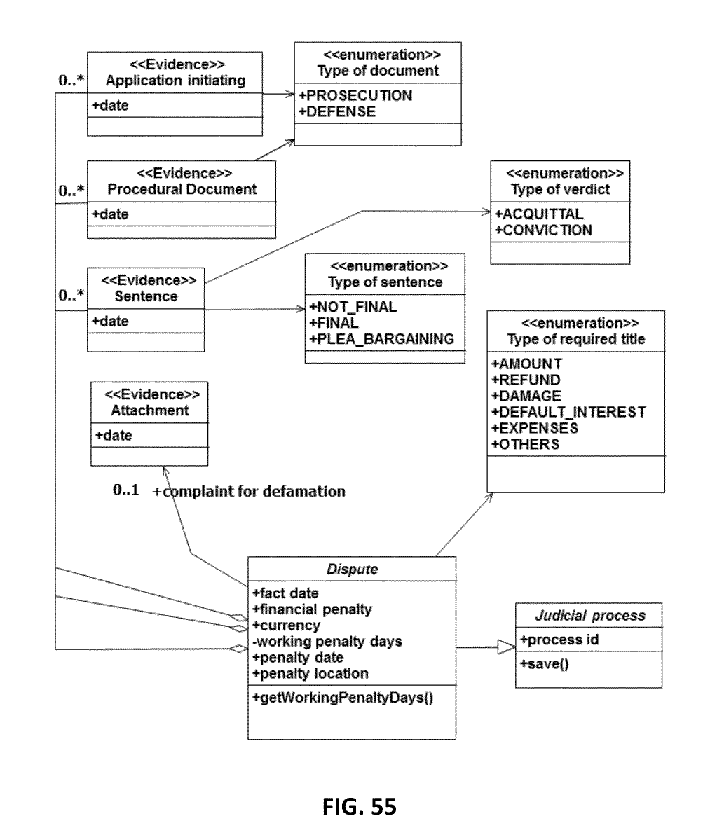

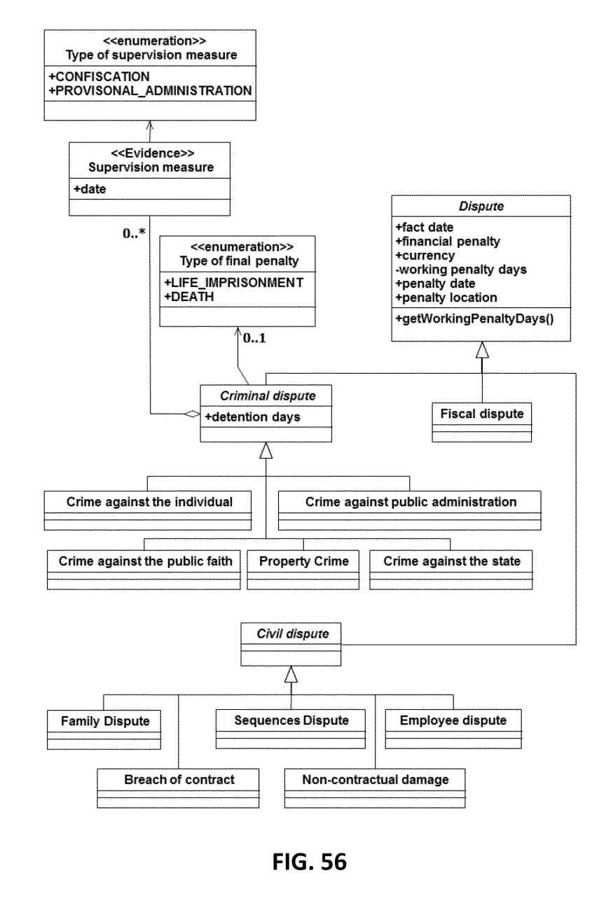

With reference to FIGS. 38 to 56, in the following it is described the logic structures of the data model about the reputational profile defined through composition and structure of class diagrams relating to the method for the determination of the reputational rating of natural and legal persons subject of the invention.

### 6.1. Reputation Diagram

FIG. 38 shows the composition of a reputational profile of a person and its relationships with the surveys.

The reputational profile of a subject (target of reputation) is composed of a set of facts; each of them is supported by documented evidence.

Facts are collected through the publication of surveys. There are two types of publications:

1. about the curriculum vitae of a person (made by the person itself, target of reputation—generally are facts pro-oneself—);

2. about judiciary processes (only one process for publication) (made by another person—generally are facts against—or by the target of reputation as reply to previous publication)

### 6.2. Evidence Diagram

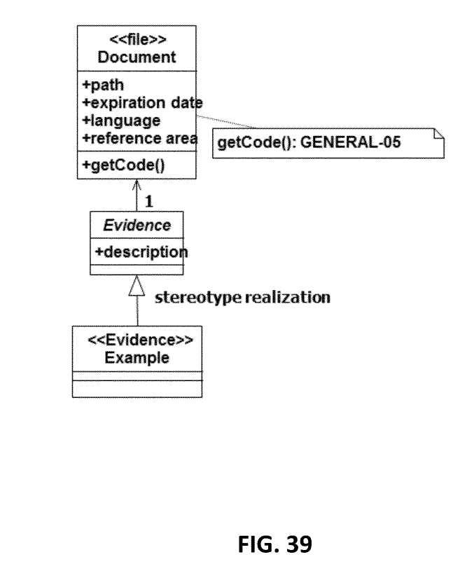

FIG. 39 shows the class diagram defining the stereotype ‘Evidence’.

Every class tagged with this stereotype is associated to a document attached as a digital evidence of a fact.

Every evidence contributes to the reputational rating

### 6.3. Profile of Registry Diagram

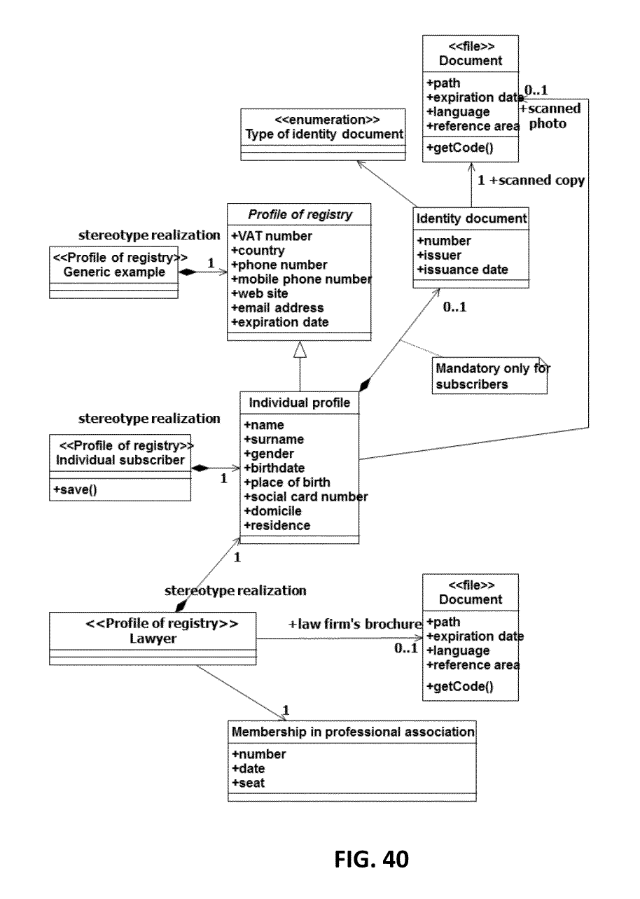

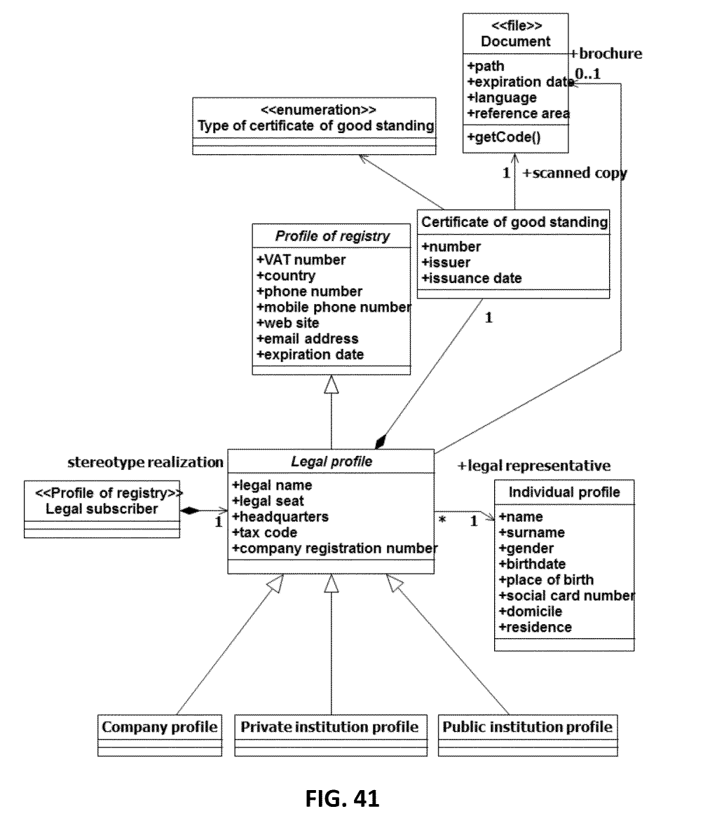

FIGS. 40, 41 show the class diagram defining the stereotype ‘Profile of registry’.

Every class tagged with this stereotype is associated to a profile of registry.

There are two specific profiles:

1—individual;

2—legal person (public or private)

The classes ‘Individual subscriber’, ‘Legal subscriber’ and ‘Lawyer’ are some examples of the stereotype's realization.

### 6.4. Curriculum Vitae Diagram

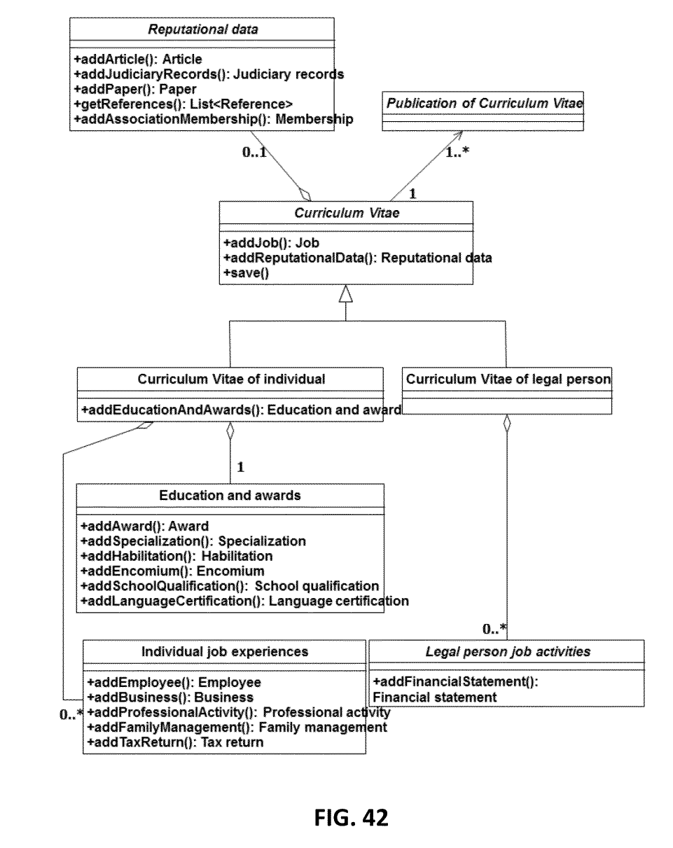

FIG. 42 shows the composition of the Curriculum Vitae of a person. The CV differs for individual and legal person.

For individuals there are three main sections:
education;
job;
reputational data (articles, references, judiciary records, . . . )

For legal person there are two main sections:
job;
reputational data (articles, references, judiciary records, . . . ).

### 6.5. Education and Awards Diagram

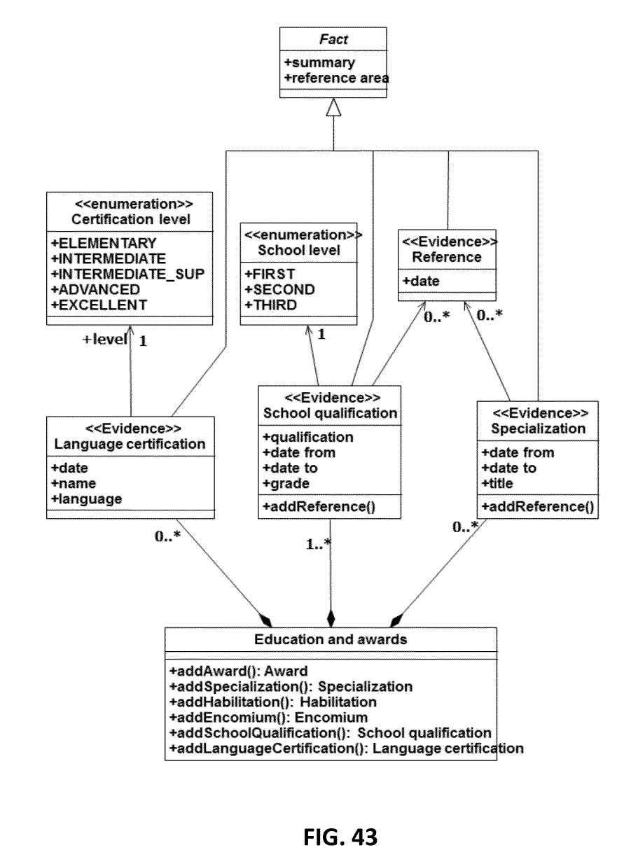

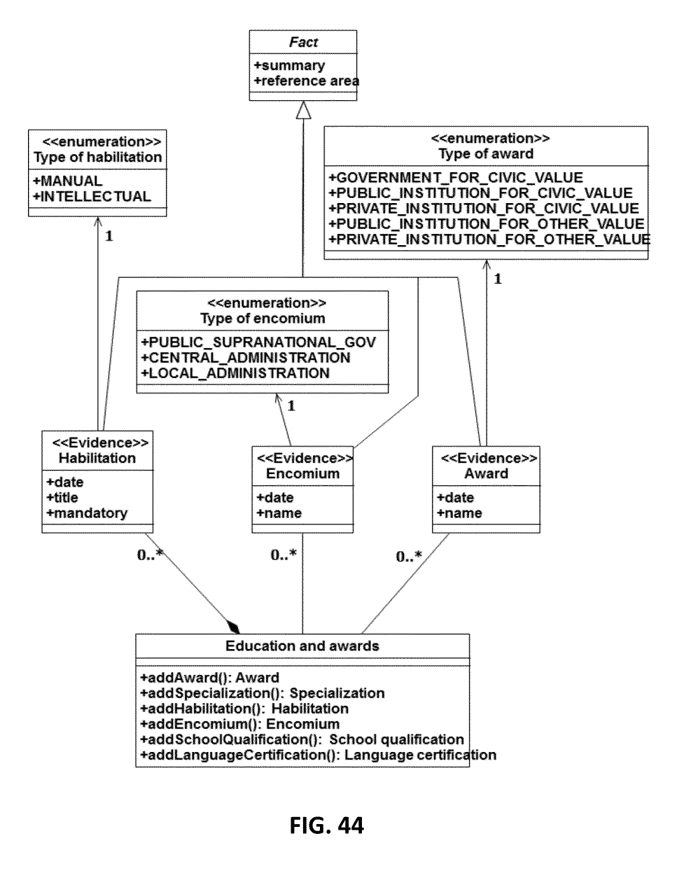

FIGS. 43, 44 show the composition of the facts related to the education of an individual, target of reputation

These facts are organized in the following sections:
school qualification;
specializations;
certifications about foreign languages;
habilitations;
encomiums;
awards.

### 6.6. Job Diagram

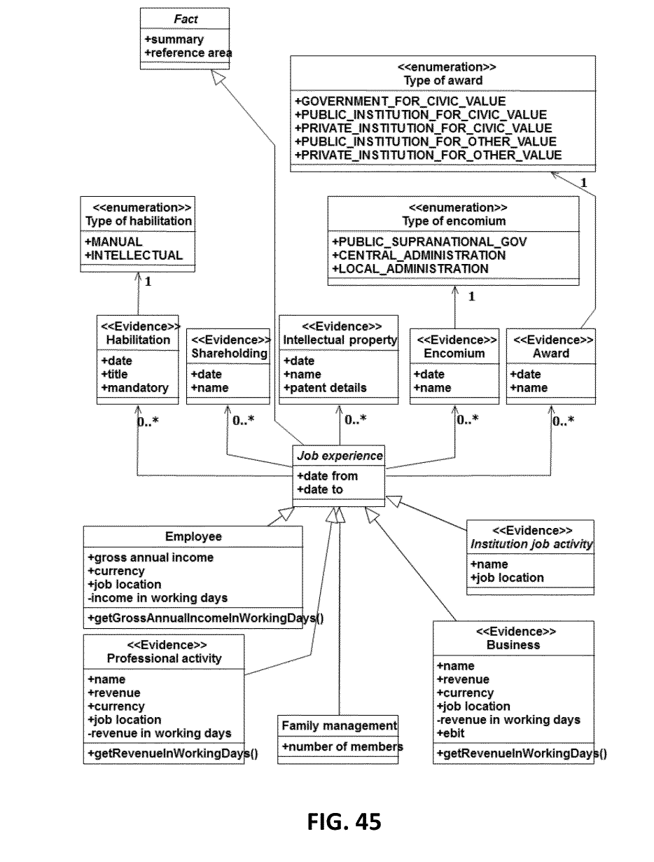

FIGS. 45, 46, 47 show the composition of the job experiences of individual and legal person.

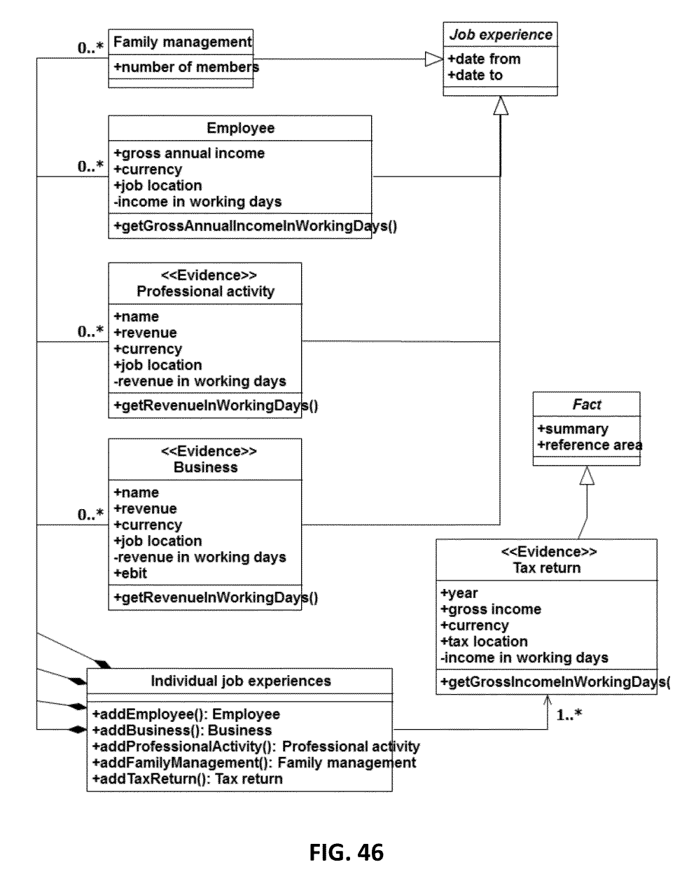

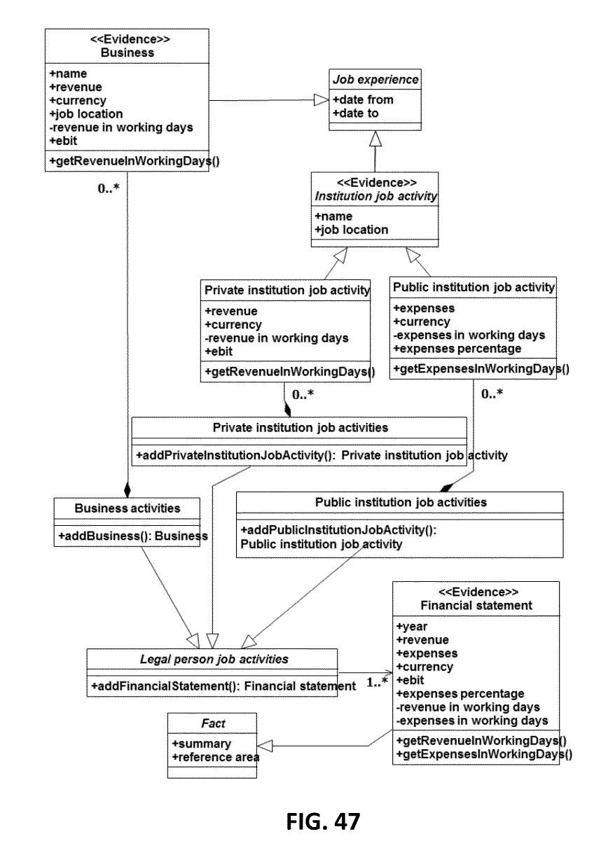

In particular FIG. 45 relates to a general overview diagram of the procedure, FIG. 46 relates to an individual, FIG. 47 relates to a legal person.

Every job experience has a start date and optionally a end date and it is a fact that contributes to the reputation.

Habilitations, awards, encomiums, shareholdings, intellectual properties, . . . are evidence that may be related to every job activity; also, each experience may be associated to specific types of evidence (i.e., engagement letter for employee).

Individual job experiences and Legal person job activities are aggregation's classes.

The class Legal person job activities is specialized for companies (Business activities) and private institutions (Private institution job activities) or public (Public institution job activities).

The class Individual job experiences is associated to the Tax returns which determine the gross annual income.

The class Legal person job activities is associated to the Financial statements which determine annual revenues, debts and expenses

In order to be used from the rating algorithm, the amount of money related to the job experiences must be measured in normalized working days.

These days are calculated with the formula:

working_days=(amount*365/GDP per capita)

where GDP per capita=daily gross domestic product per capita related to the year during which the amount was defined.

This means that the value of working days depends on the activity starting date (Job experience.date to) and the location of the job.

### 6.7. Job—Individual, Employee Diagram

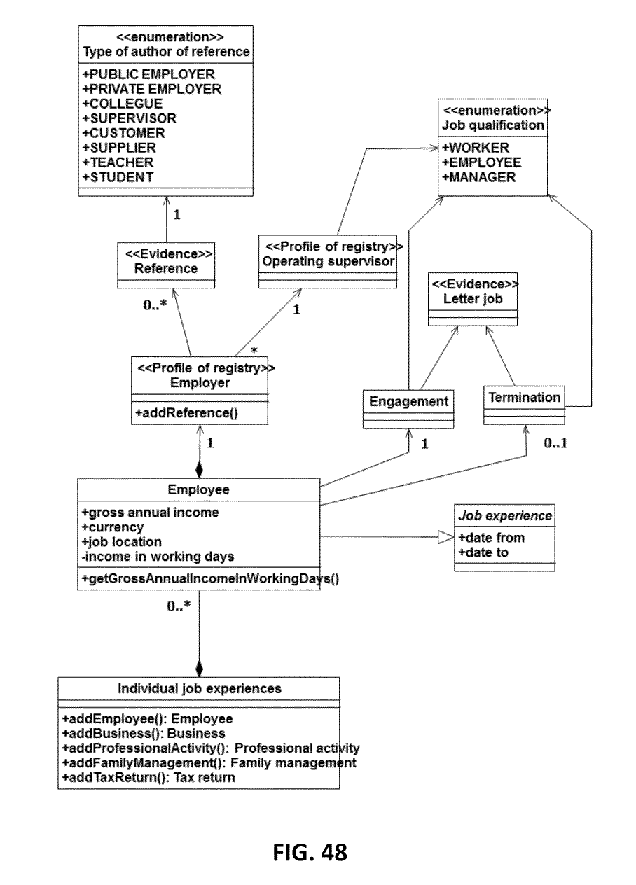

FIG. 48 shows the composition of the individual employee.

It includes the working experiences of the individual in particular as an employee.

### 6.8. Job—Individual, Professional and Business Diagram

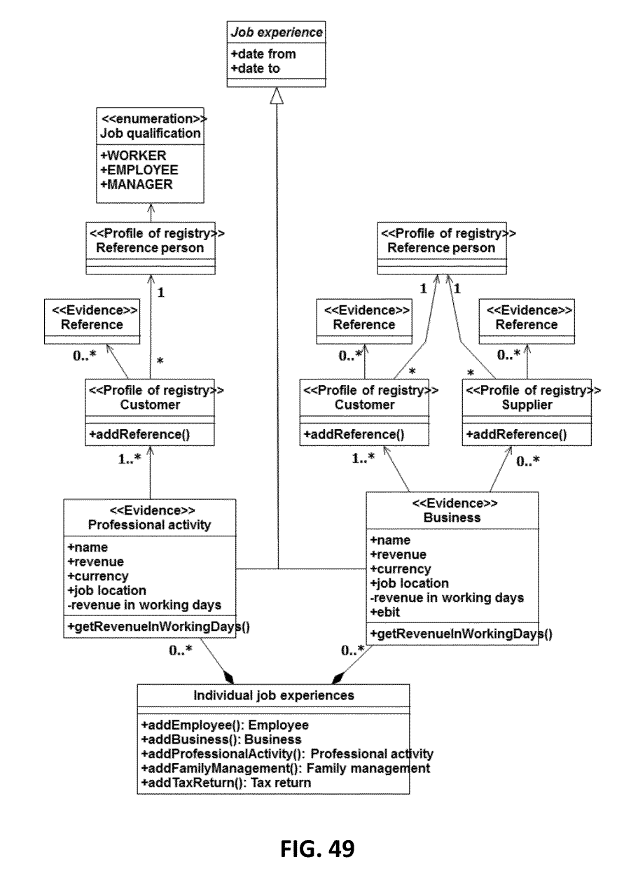

FIG. 49 shows the composition of the professional and business activities of individuals.

It includes details on the professional and business activities.

### 6.9. Job—Legal Person, Business Diagram

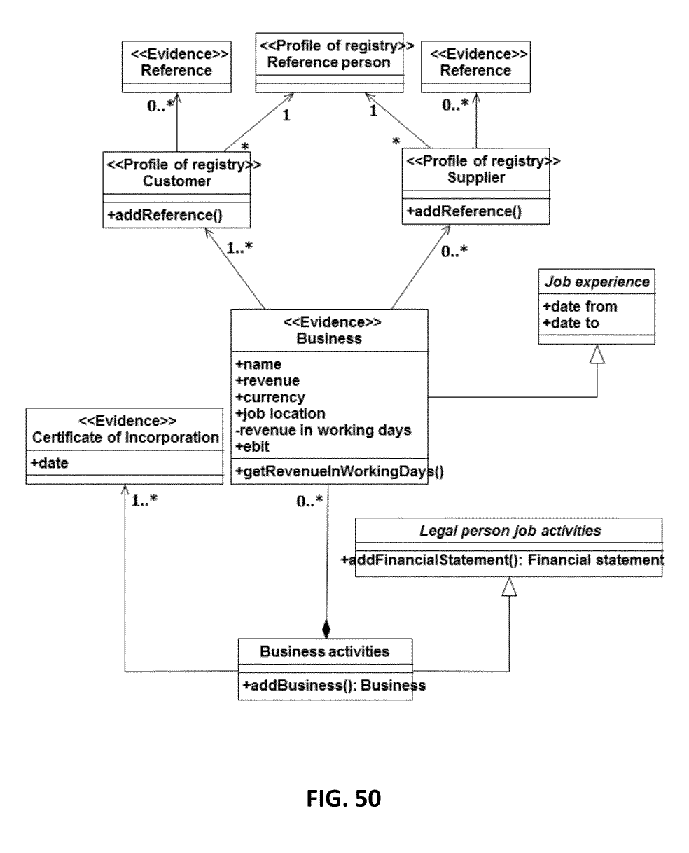

FIG. 50 shows the composition of the professional and business activities of a legal person.

### 6.10. Job—Legal Person, Institutions Diagram

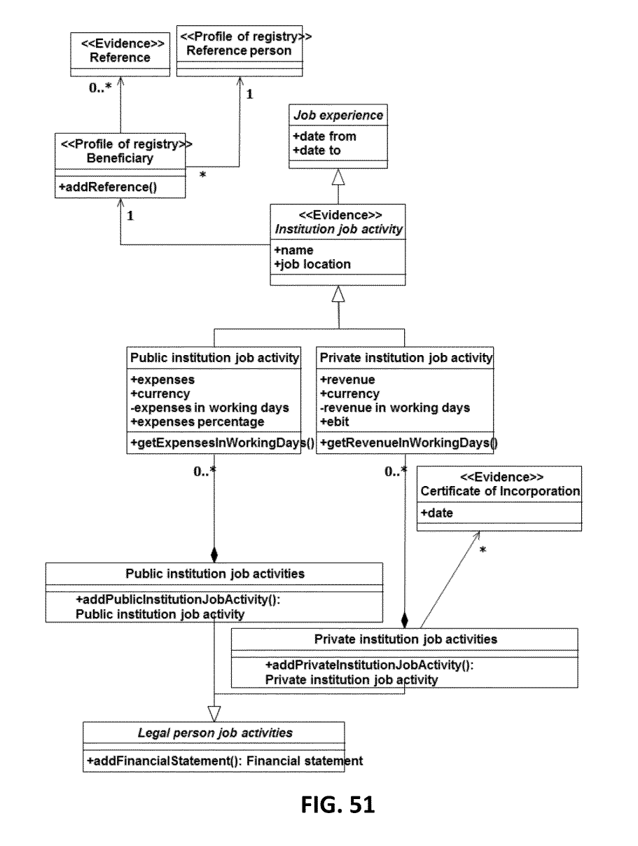

FIG. 51 shows the composition of the job activities of private or public institutions.

### 6.11. Reputational Data Diagram

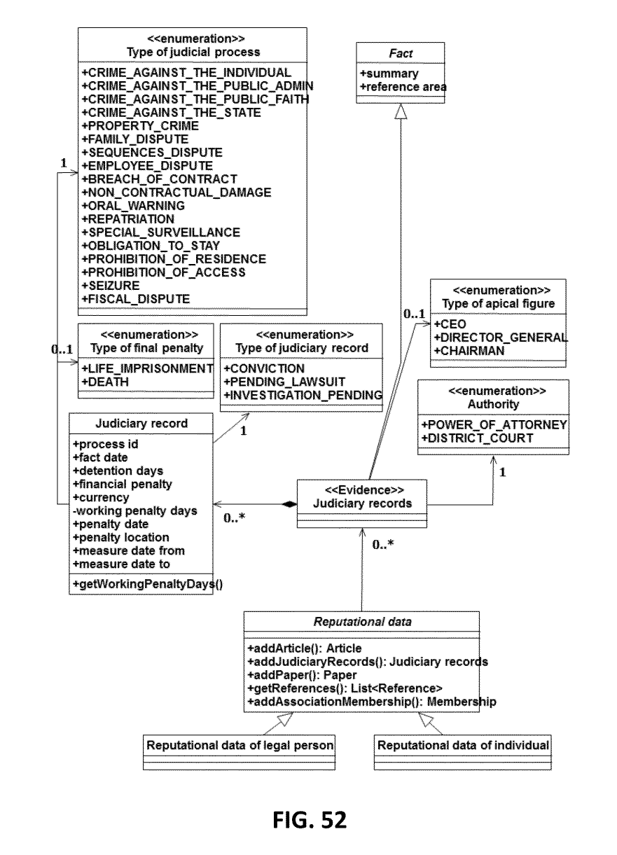

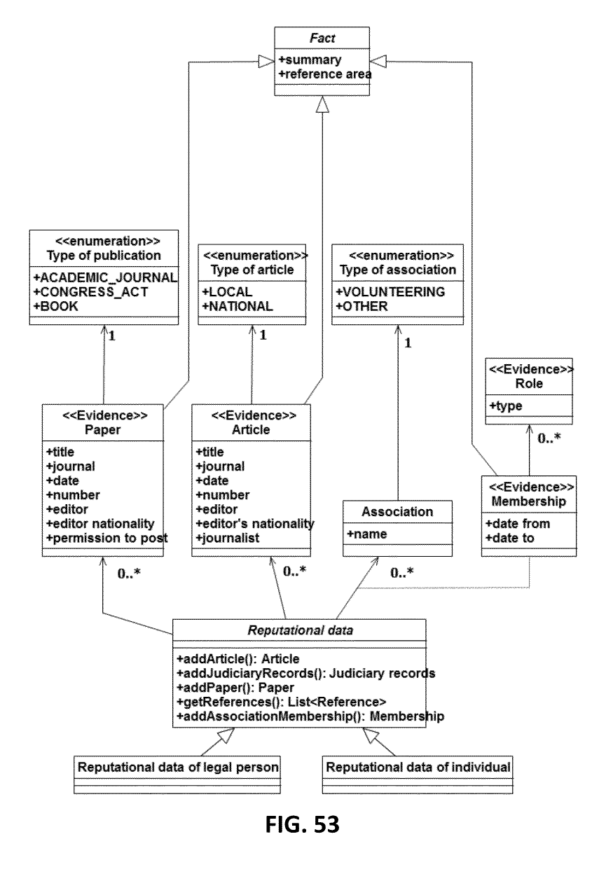

FIGS. 52, 53 show the composition of the reputational data of an individual or a legal person.

The facts are organized in the following sections:
judiciary records;
references (linked from previous sections);
social activities (memberships in volunteering associations), paper written by the person and articles about the person.

### 6.12. Disputes Diagram

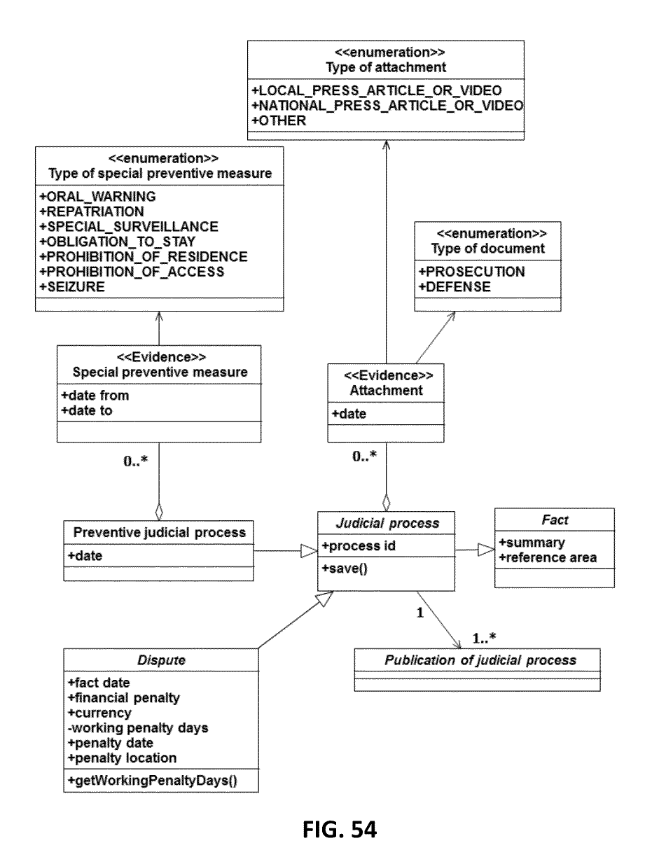

FIGS. 54, 55, 56 show the composition of the judicial processes of an individual or a legal person.

There are two classes of judicial processes:
special preventive measure, based on the presumption of a danger;
dispute, based on the investigation about a crime or a damage.

Every dispute is associated to some documents (initiating acts, procedural documents, sentences, attachments).

There are three types of dispute: criminal dispute, fiscal dispute, civil dispute.

Criminal dispute and civil dispute have some specializations based on the crime or the civil area:

1. criminal dispute:

crime against the individual

property crime

crime against public administration

crime against the public faith

crime against the state

2. civil dispute:

family

sequences

employee

breach of contract

non contractual damage

### 7. Description of the Classes

In the following a description is given of the meaning of the various objects or terms and enumerations used for describing the classes referred to the FIGS. 38-56.

### 7.1—Analysis—Classes

Reputation—Against third reply. Class of the publications of a reply to a survey against a third party about a Judicial process. It extends Publication of judicial process. The third party, Target of reputation, should be advised when a ‘Contribution against third’, ‘Survey against third’ or ‘Integration against third’ occurred. Then he can upload documents in defense.

Reputation—Association. Class of the professional associations that assist the Subscriber of the system. It is stereotyped with ‘Profile of registry’, so every instance is associated to a Profile of registry (Legal profile).

Reputation—Contribution against third party. Class of the contributions to a survey against a third party, about a Judicial process. It extends Publication of judicial process. Contributions are integrations to the survey submitted by a Subscriber different from the one who has created the survey.

Reputation—Counsel. Abstract class of the counsels that assist a Subscriber in the Publication of facts. May be a Lawyer or an Association.

Reputation—Curriculum Vitae. Abstract class of the Curricula Vitae. Its specializations depend on the type of person: Curriculum Vitae of individual or Curriculum Vitae of legal person. The sections of the CV are edited through the services ‘Publication of Curriculum Vitae’.

Reputation—Curriculum Vitae of individual. Class of the Curricula Vitae of individuals. It extends Curriculum Vitae. It's composed by three sections: Education and awards; Job experiences; Reputational data (inherited from the parent class).

Reputation—Curriculum Vitae—Curriculum Vitae of legal person. Class of the Curricula Vitae of legal persons. It extends Curriculum Vitae. It's composed by two sections: Job experiences; Reputational data (inherited from the parent class).

Reputation—Curriculum Vitae—Education and awards. Aggregation class of the information about the education of an individual. It's composed by: School qualifications; Specializations; Certifications about knowledge of foreign language; Habilitations obtained during educational experiences; Encomiums obtained during educational experiences; Awards obtained during educational experiences.

Reputation—Curriculum Vitae—Education and awards—Language certification. Class of the certifications of the knowledge of a foreign language. It extends Fact. The class has the following attributes: date: date of achievement; name: certification's name; language: the language code (ISO 639-1); level: the knowledge's level (Certification level). Furthermore, it's stereotyped with <<Evidence>>, so every instance is associated to the copy of the certificate (uploaded).

Reputation—Curriculum Vitae—Education and awards—School qualification. Class of the school qualifications. It extends Fact. The class has the following attributes: qualification: qualification's name; date from: starting date of study; date to: graduation date; grade: grade expressed as the fraction of maximum. Furthermore, it's associated to the School level and optionally to teacher's References. Finally, it's stereotyped with <<Evidence>>, so every instance is associated to the copy of the school certificate (uploaded).

Reputation—Curriculum Vitae—Education and awards—Specialization. Class of the information about a specialization. It extends Fact. The class has the following attributes: date from: starting date of study; date to: date of achievement; title. Furthermore, it's optionally associated to teacher's References. Finally it's stereotyped with <<Evidence>>, so every instance is associated to the copy of the specialization's certificate (uploaded).

Reputation—Curriculum Vitae—Job—Beneficiary. Class of the job relationships to a person beneficiary of the activity, member of an association. The class is associated to: Reference's letters, optionally; Reference person in this job context. It's stereotyped with <<Profile of registry>>, so every instance is associated to the complete profile of registry of the reference person.

Reputation—Curriculum Vitae—Job—Business activities. Aggregation class of the business activities of a private legal person. It extends Legal person job activities. It's composed by: a set of Business instances. Furthermore, the class is associated to: Certificate of Incorporation.

Reputation—Curriculum Vitae—Job—Individual job experiences. Aggregation class of the job experiences for an individual. It's composed by: Family management's experiences; Employees; Professional activities; Business activities. Furthermore, the class is associated to: Tax returns.

Reputation—Curriculum Vitae—Job—Individual profile—Employee. Class of the information about employee. It's extends Job experience. The class has the following attributes: gross annual income; currency; job location: main country for the activity (country code ISO 3166-1 alpha-2); income in working days (see rating algorithm). Furthermore it's associated to: Employer; information abount Engagement; optionally, information about Termination.

Income in working days is calculated in the following way:

(gross annual income*365/GDP per capita)

with GDP per capita=daily gross national product per capita.

So this evaluation depends on a date (Job experience.date to) and on a country (job location).

Reputation—Curriculum Vitae—Job—Individual profile—Employer. Class of the job relationships with an employer. The class it's associated to: Reference's letters, optionally; the last Operating supervisor in the job context. It's stereotyped with <<Profile of registry>>, so every instance is associated to the complete profile of registry of the employer.

Reputation—Curriculum Vitae—Job—Individual profile—Engagement. Class of the information about engagement of an employee. The class is associated to: Job qualification; Letter job.

Reputation—Curriculum Vitae—Job—Individual profile—Family management. Class of the job activities in family management. It extends Job experience. The class has the following attributes: number of members: number of family's member.

Reputation—Curriculum Vitae—Job—Individual profile—Letter job. Class of the generic job letters (about engagement, termination, . . . ). It's stereotyped with <<Evidence>> so every instance is associated to a scanned copy of the letter (uploaded).

Reputation—Curriculum Vitae—Job—Individual profile—Operating supervisor. Class of the operating supervisors or reference persons in the employee context. It's stereotyped with <<Profile of registry>>, so every instance is associated to the complete profile of the supervisor.

Reputation—Curriculum Vitae—Job—Individual profile—Professional activity. Class with information about a professional activity. It extends Job experience. The class has the following attributes: name; revenue; currency; job location: main country for the activity (country code ISO 3166-1 alpha-2); revenue in working days (see rating algorithm). Furthermore it's associated to: Customer.

Revenue in working days is calculated in the following way:

(revenue*365/GDP per capita)

with GDP per capita=daily gross national product per capita.

So this evaluation depends on a date (Job experience.date to) and on a country (job location). Finally, the class is stereotyped with <<Evidence>>, so every instance is associated to a copy of the job contract (uploaded).

Reputation—Curriculum Vitae—Job—Individual profile—Tax return. Class of the tax return documents. It extends Fact. The class has the following attributes: year: fiscal year; gross income; currency; tax location: fiscal country (country code ISO 3166-1 alpha-2); income in working days (see rating algorithm). Income in working days is calculated in the following way:

(gross income*365/GDP per capita)

con GDP per capita=daily gross national product per capita.

So this evaluation depends on the tax return's year and the tax location. Furthermore, the class is stereotyped with <<Evidence>>, so every instance is associated to a uploaded copy of the document.

Reputation—Curriculum Vitae—Job—Individual profile—Termination. Class of the information about the termination of an employee. The class is associated to: Job qualification; Letter job.

Reputation—Curriculum Vitae—Job—Institution job activity. Class of the job activities of an institution. It extends Job experience and it's abstract. Specialization's classes are Private institution job activity and Public institution job activity. The class has the following attributes: name; job location: main country for the activity (country code ISO 3166-1 alpha-2). Furthermore, it's associated to: a Beneficiary. Finally, the class is stereotyped with <<Evidence>>, so every instance is associated to a copy of the job contract (uploaded).

Reputation—Curriculum Vitae—Job—Intellectual property. Class of the patents or other intellectual properties obtained by the person, Target of reputation. The class has the following attributes: date; name; patent details. Furthermore, the class is stereotyped with <<Evidence>>, so every instance is associated to a copy of patent's document (uploaded).

Reputation—Curriculum Vitae—Job—Job experience. Class of the generic job experiences realized during a period. The class is abstract and extends Fact. Specializations classes depend on the type of person, Target of reputation: Family management (individual); Employee (individual); Professional activity (individual); Business (individual and private legal person); Institution job activity (institutions, public or private). The class has the following attributes: date from: starting date; date to: termination date (if not specified, date to=date of registration for the activity). Furthermore, it's optionally associated to: Habilitations; Shareholdings; Intellectual properties; Encomiums; Awards; related to the experience.

Reputation—Curriculum Vitae—Job—Legal person job activities. Aggregation class of the job activities of a legal person. The class is abstract and it's specialized for the companies (Business activities), private institutions (Private institution job activities) and public institutions (Public institution job activities). Furthermore, the class is associated to: Financial statements.

Reputation—Curriculum Vitae—Job—Legal profile—Certificate of Incorporation. Class of the certificates of incorporation of a legal person. The class has the following attributes: date: issuing date of certificate. The class is stereotyped with <<Evidence>>, so every instance is associated to a copy of the certificate (uploaded). Generally it's required to update this certificate often.

Reputation—Curriculum Vitae—Job—Legal profile—Financial statement. Class of the financial statements of a legal person. It extends Fact. The class has the following attributes: year; revenue; expenses; currency; ebit; expenses percentage: percentage of administrative expenses; revenue in working days (see rating algorithm); expenses in working days (see rating algorithm). Revenue and expenses in working days are calculated in the following way:

(revenue*365/GDP per capita)

(expenses*365/GDP per capita)

with GDP per capita=daily gross national product per capita.

So this evaluations depend on the financial year and the country of the related legal person (profile of registry.country). Finally, the class is stereotyped with <<Evidence>>, so every instance is associated to a copy of the statement (uploaded).

Reputation—Curriculum Vitae—Job—Legal profile—Private institution job activity. Class of the job activities of private institutions. It extends Institution job activity. The class has the following attributes: revenue; currency; revenue in working days (see rating algorithm); ebit. Revenue in working days is calculated in the following way:

(revenue*365/GDP per capita)

with GDP per capita=daily gross national product per capita. So this evaluation depends on a date (Job experience.date to) and on a country (Institution job activity.job location).

Reputation—Curriculum Vitae—Job—Legal profile—Public institution job activity. Class of the job activities of public institutions. It extends Institution job activity. The class has the following attributes: expenses; currency; expenses in working days (see rating algorithm); expenses percentage: percentage of administrative expenses. Expenses in working days are calculated in the following way:

(expenses*365/GDP per capita)

with GDP per capita=daily gross national product per capita. So this evaluation depends on a date (Job experience.date to) and on a country (Institution job activity.job location).

Reputation—Curriculum Vitae—Job—Private institution job activities. Aggregation class of the job activities of a private institution. It extends Legal person job activities. It's composed by: Private institution job activities. Furthermore, the class is associated to: Certificates of Incorporation.

Reputation—Curriculum Vitae—Job—Public institution job activities. Aggregation class of the job activities of a public institution. It extends Legal person job activities. It's composed by: Public institution job activities.

Reputation—Curriculum Vitae—Job—Shareholding. Class with the information about a shareholding owned by the person, Target of reputation. The class has the following attributes: date: acquisition date; name. Furthermore, the class is stereotyped with <<Evidence>>, so every instance is associated to a copy of the acquisition's certificate (uploaded).

Reputation—Curriculum Vitae—Job—common—Business. Class of the information about a business. It extends Job experience. The class has the following attributes: name; revenue; currency; job location: main country for the activity (country code ISO 3166-1 alpha-2); revenue in working days (see rating algorithm); ebit: ebit of the business. Furthermore it's associated to: Customers; Suppliers (optional). Revenue in working days is calculated in the following way:

(revenue*365/GDP per capita)

with GDP per capita=daily gross national product per capita. So this evaluation depends on a date (Job experience.date to) and on a country (job location). Finally, the class is stereotyped with <<Evidence>>, so every instance is associated to a copy of the business contract (uploaded).

Reputation—Curriculum Vitae—Job—common—Customer. Class of the job relationships with a customer. The class is associated to: reference's letter (Reference), optional; the Reference person in this job context. It's stereotyped with <<Profile of registry>>, so every instance is associated to the complete profile of registry of the customer.

Reputation—Curriculum Vitae—Job—common—Reference person. Class of the reference person in a fixed job context or relationship. It's stereotyped with <<Profile of registry>> so every instance is associated to the complete profile of registry of the reference person.

Reputation—Curriculum Vitae—Job—common—Supplier. Class of the job relationships with a supplier. The class is associated to: reference's letter (Reference), optional; the Reference person in this job context. It's stereotyped with <<Profile of registry>>, so every instance is associated to the complete profile of registry of the supplier.

Reputation—Curriculum Vitae—Reputational data—Article. Class of the articles (video or printed) about the Target of reputation. It extends Fact. The class has the following attributes: title; journal; date: publication's date; number: number of journal; editor; editor nationality (country code ISO 3166-1 alpha-2); journalist; Type of article. Furthermore, it's stereotyped with <<Evidence>>, so every instance is associated to the copy of the article (uploaded).

Reputation—Curriculum Vitae—Reputational data—Association. Class of the associations of individuals or legal persons (e.g. Rotary Club, Lions Club). The class is associated to: Type of association.

Reputation—Curriculum Vitae—Reputational data—Judiciary record. Class of the single judiciary records related to a Judicial process. This process may be yet registered through a Survey against a third party or not. The class has the following attributes: process id: identifier of the process; fact date; detention days (only criminal processes); financial penalty (optional); currency: currency of financial penalty; working penalty days: financial penalty in working days (see below); penalty date: when the penalty was assigned (judgment date); penalty location: country of the court (country code ISO 3166-1 alpha-2); measure date from: starting date for Special preventive measure; measure date to: end date for Special preventive measure. Furthermore, the class is associated to: Type of judicial process; Type of judiciary record; Type of final penalty (optional). Every records may specify detention days and a financial penalty expressed in money or in working days. This working days are calculated in the following way:

(financial penalty*365/GDP per capita)

with GDP per capita=daily gross national product per capita. So this evaluation depends on the date (penalty date) and the country (penalty location). This class is persistent.

Reputation—Curriculum Vitae—Reputational data—Judiciary records. Class of the certificates composed by the judiciary records of a person, issued by an Authority. It's associated to: a set of Judiciary record; the judicial Authority. The class is stereotyped with <<Evidence>>, so every instance is associated to the uploaded certificate.

Reputation—Curriculum Vitae—Reputational data—Membership. Class of the memberships in an association. It extends Fact. The class has the following attributes: date from: registration date; date to: date of leaving (optional). Furthermore, it's optionally associated to Roles in the association. Finally, it's stereotyped with <<Evidence>>, so every instance is associated to the copy of the membership's certificate (uploaded).

Reputation—Curriculum Vitae—Reputational data—Paper. Class of the publications realized by the person, Target of reputation. It extends Fact. The class has the following attributes: title; journal; date: publication's date; number: number of journal; editor; editor nationality (country code ISO 3166-1 alpha-2); permission to post (flag); Type of publication. Furthermore, it's stereotyped with <<Evidence>>, so every instance is associated to the copy of the paper (uploaded).

Reputation—Curriculum Vitae—Reputational data—Reputational data. Aggregation class of the reputational data of a person. The class is abstract and its specializations depend on the type of person, Target of reputation: Reputational data of individual and Reputational data of legal person. Reputational data are composed by: Judiciary records; References; information about civil activities (membership in volunteering associations, . . . ); information about social activities (articles about the person, papers, . . . ).

Reputation—Curriculum Vitae—Reputational data—Reputational data of individual. Class of the reputational data of an individual. It extends Reputational data.

Reputation—Curriculum Vitae—Reputational data—Reputational data of legal person. Class of the reputational data of a legal person. It extends Reputational data.

Reputation—Curriculum Vitae—Reputational data—Role. Class of the roles attributed to a member of an Association. The class has the following properties: type (e.g. chairman). Furthermore, it's stereotyped with <<Evidence>>, so every instance is associated to the copy of the attribution's letter (uploaded).

Reputation—Curriculum Vitae—common—Award. Class of the awards assigned to the person, Target of the reputation. It extends Fact. The class has the following attributes: date: date of assignment; name. Furthermore, it's stereotyped with <<Evidence>>, so every instance is associated to the copy of the award's certificate (uploaded).

Reputation—Curriculum Vitae—common—Encomium. Class of the encomiums assigned to the person, Target of the reputation. It extends Fact. The class has the attributes below: date: date of assignment; name. Furthermore, it's stereotyped with <<Evidence>>, so every instance is associated to the copy of the encomium's certificate (uploaded).

Reputation—Curriculum Vitae—common—Habilitation. Class of the habilitations obtained during an educational experience or on the job. It's extends Fact. Habilitation can be mandatory or optional regarding the context (education, job). The class has the following attributes: date: date of achievement; title; mandatory (flag). Furthermore it's stereotyped with <<Evidence>>, so every instance is associated to the copy of the habilitation's certificate (uploaded).

Reputation—Curriculum Vitae—common—Reference. Class of the documented reference's letters. It's associated to the Type of author. The class is stereotyped with <<Evidence>>, so every instance is associated to the scanned copy of the reference's letter.

Reputation—Discrepancies—Discrepancy. Class of the discrepancies found in a Publication of facts. The class has the following attributes: date: date of discrepancy's report; title; description; fix: the description of the fix applied; state: the State of discrepancy. Furthermore it's associated to: the invalid Fact; the related Publication of facts; the Subscriber reporter. The class is persistent.

Reputation—Disputes—Application initiating. Class of the application initiating acts of a Dispute. These acts may be for the prosecution or for the defense. The class has the following attributes: date: date of submission. Furthermore, the class is stereotyped with <<Evidence>>, so every instance is associated to the uploaded copy of the act.

Reputation—Disputes—Attachment. Class of the documents attached to a Dispute. These documents are Accessory Acts for prosecution or for defense. The class has the following attributes: date: date of submission. And it's associated to: Type of attachment. Furthermore, the class is stereotyped with <<Evidence>>, so every instance is associated to the uploaded copy of the attachment.

Reputation—Disputes—Breach of contract. Class of the disputes about breaches of contract. It extends Civil dispute. It's related to individuals or legal persons (private or public).

Reputation—Disputes—Civil dispute. Abstract class of the civil disputes. It extends Dispute and its specializations depend on the argument of the dispute.

Reputation—Disputes—Crime against public administration. Class of the disputes about crimes against the public administration. It extends Criminal dispute. It's related to individuals or legal persons (private or public).

Reputation—Disputes—Crime against the individual. Class of the disputes about crimes against the individual. It extends Criminal dispute. It's related to individuals.

Reputation—Disputes—Crime against the public faith. Class of the disputes about crimes against the public faith. It extends Criminal dispute. It's related to individuals or legal persons (private or public).

Reputation—Disputes—Crime against the state. Class of the disputes about crimes against the state. It extends Criminal dispute. It's related to individuals or legal persons (private or public).

Reputation—Disputes—Criminal dispute. Abstract class of the criminal disputes. It extends Dispute and its specializations depend on the type of crime. In the case of conviction (through a sentence), a detention penalty can be assigned. This detention may be for a limited period (detention days fixed) or unlimited (Type of final penalty set). If the judgment is not yet given (sentence doesn't exist), penalty days are set to the maximum possible value. The class has the following attributes: detention days: jail time; and associations to: Type of final penalty, optionally; Supervision measures, optionally.

Reputation—Disputes—Dispute. Abstract class of the disputes. It extends Judicial process. Every dispute is created and integrated through a sequence of Publications of dispute. The class has the following attributes: fact date; financial penalty (optional); currency: currency of financial penalty; working penalty days: financial penalty in working days (see below); penalty date: when the penalty was assigned (judgment date); penalty location: country of the court (country code ISO 3166-1 alpha-2); Type of required title. Furthermore, the class is associated to a set of Evidence (judicial acts): Application initiatings; Procedural Documents; Sentences. Optionally it may exist a particular associated Attachment, the complaint for defamation. If it exists, the financial penalty is represented in money or in working days. These working days are calculated in the following way:

(financial penalty*365/GDP per capita)

with GDP per capita=daily gross national product per capita. So this evaluation depends on the date (penalty date) and the country (penalty location).

Note: the information about the penalty is related to the last available sentence, the only useful for the rating algorithm. If the judgment is not yet given (sentence doesn't exist), financial penalty is set to the maximum possible value and the penalty date is the date of registration of the dispute.

Reputation—Disputes—Employee dispute. Class of the disputes about employees. It extends Civil dispute. It's related to individuals or legal persons (private or public).

Reputation—Disputes—Family Dispute. Class of the disputes concerning the family. It extends Civil dispute. It's related to individuals.

Reputation—Disputes—Fiscal dispute. Class of the fiscal disputes. It extends Dispute. It's related to individuals or legal persons (private or public).

Reputation—Disputes—Judicial process. Abstract class of the judicial processes. It extends Fact. The Judicial process is specialized in two classes: Preventive judicial process, applied when a person is dangerous, before the realization of fact; Dispute, instantiated when a crime or a procured damage occurred. The class has the following attributes: process id: process identifier. Furthermore, the class may have Attachments for prosecution or defense.

Reputation—Disputes—Non-contractual damage. Class of the disputes about non contractual damages. It extends Civil dispute. It's related to individuals or legal persons (private or public).

Reputation—Disputes—Preventive judicial process. Classes of the judicial processes that must decide about the dangerousness of a person. It extends Judicial process. The class has the following attributes: date: date of judgment. Furthermore it's associated to Special preventive measures.

Reputation—Disputes—Procedural Document. Class of the procedural documents in a Dispute. Every document is presented for prosecution or defense. The class has the following attributes: date: presentation date. The class is stereotyped with <<Evidence>>, so every instance is associated to the uploaded copy of the act.

Reputation—Disputes—Property Crime. Class of the disputes about property crimes. It extends Criminal dispute. It's related to individuals or legal persons (private or public).

Reputation—Disputes—Sentence. Class of the sentences of a Dispute. Every sentence has a Type of sentence and a Type of verdict. Furthermore, the class has the following attribute: date: date of the sentence (judgment date). The class is stereotyped with <<Evidence>>, so every instance is associated to the uploaded copy of the act.

Reputation—Disputes—Sequences Dispute. Class of the disputes about sequences. It extends Civil dispute. It's related to individuals or legal persons (private or public).

Reputation—Disputes—Special preventive measure. Class of the special preventive measures. Special preventive measures may be assigned even if the crime or a procured damage is not yet occurred; these measures are issued at the end of a Preventive judicial process. The class has the following attributes: date from: starting date for the measure; date to: termination date for the measure. The class is stereotyped with <<Evidence>>, so every instance is associated to the uploaded copy of the act.

Reputation—Disputes—Supervision measure. Class of the supervision measures. A supervision measure is an additional measure, determined with the sentence, to prevent the realizations of new crimes. The class has the following attributes: date: date of assignment. The class is stereotyped with <<Evidence>>, so every instance is associated to the uploaded copy of the act.

Reputation—Fact. Class of the elements which compose the Reputation of a person. Every Fact must be supported through Evidence. The class has the following attributes: summary; reference area: the section of survey where the Fact is presented; state. This class and all its specializations are persistent.

Reputation—Integration against third party. Class of the integrations to the survey against a third party, related to a judicial process. It extends Publication of judicial process. Integrations are submitted from the same Subscriber that has created the survey.

Reputation—Integration pro-oneself. Class of the integrations to a surveys pro-oneself. It extends Publication of Curriculum Vitae.

Reputation—Publication of Curriculum Vitae. Abstract of the publications of Curriculum Vitae. Publications of CV happen through the creation of a Survey pro-oneself and subsequent Integrations pro-oneself

Reputation—Publication of facts. Abstract class of the publications of facts. There are two types of publications: about Facts generally presented in the Curriculum Vitae of a person (Facts pro-oneself, submitted by the person, Target of reputation); about Judicial processes (1 process for 1 publication—ref. ‘Disputes diagram’) (Facts certainly against, with the exception of the replies in defense). Every publication is related to a Subscriber and optionally to a Counsel. This class and all its specializations are persistent.

Reputation—Publication of judicial process. Abstract class of the publications of judicial process. A publication of a Judicial process happens—first—through the creation of a Survey against third, and—second—through the subsequent Integrations against third, realized by the same Subscriber, or through the subsequent Contributions against third, realized by another Subscriber. The third party (Target of reputation) may reply to the survey—through the service Against third reply—, submitting Evidence in defense.

Reputation—Reputation. Class of the reputations of person, defined through documented Facts. It's associated to a rating evaluated on demand (ref method getRating( )), with a synthetic presentation of the facts or a complete (analytic) presentation. The methods getNumXXX( ) return information about the number of actors related to the publications. In particular, the methods getNumProSubscriber( ) and getNumAgainstSubscriber( ) return always 0 or 1.

Reputation—Reputational profile. Class of the reputational profiles of person (individual or legal), target of the surveys. The class has the following attributes: code: reputational code (ref use case Surveys—Generate reputational code). The class is persistent.

Reputation—Survey against third party. Class of the surveys against a third party, related to a Judicial process. It extends Publication of judicial process. The class has the following attributes: abstract: the abstract of the judicial process.

Reputation—Survey pro-oneself. Class of the surveys pro-oneself. It extends Publication of Curriculum Vitae.

Reputation—Target of reputation. Class of the person, Target of the reputation. In the case of Publications of surveys against a third party, the target is the third party; in the case of Publications of CV, the target is the Subscriber of the service. It is stereotyped with ‘Profile of registry’, so every instance is associated to a Profile of registry.

Stereotypes—Evidence—Evidence. Abstract class of the evidence related to a Fact. The rating algorithm assigns a value to every evidence declared in the Reputational profile. This evaluation depends by the metadata of each evidence; the metadata are composed by the specific type of the instance and the values of its enumerated attributes. The class has a relationship to the file uploaded to prove the Fact and has the following attributes: description: description of the evidence. This class and all its specializations are persistent.

Stereotypes—Evidence—Example. Example class stereotyped with ‘Evidence’. The stereotype means that the class extends Evidence.

Stereotypes—Profile of registry—Certificate of good standing. Classes of the certificates of good standing (or equivalent). A certificate of good standing is the document that identify the legal person. The class has the following attributes: number: certificate's identifier; issuer: the issuer authority; issuance date: the issuance date. It is associated to the scanned copy uploaded and to the Type of certificate of good standing. The class is persistent.

Stereotypes—Profile of registry—Company profile. Classes of the profiles of registry of a company. It extends Legal profile.

Stereotypes—Profile of registry—Generic example. Example class stereotyped with ‘Profile of registry’. The stereotype means that every instance of this class is associated (by composition) to an instance of Profile of registry.

Stereotypes—Profile of registry—Identity document. Classes of the identity documents. The class has the following attributes: number: certificate's identifier; issuer: the issuer authority; issuance date: the issuance date. It is associated to the scanned copy uploaded and to the Type of identity document. The class is persistent.

Stereotypes—Profile of registry—Individual profile. Classes of the profiles of registry for individual. It extends Profile of registry. The class has the following attributes: name; surname; gender; birthdate; place of birth; social card number; domicile: address of domicile; residence: address of residence.

Furthermore it's associated to: the Identity document; an optional uploaded personal photo.

Stereotypes—Profile of registry—Individual subscriber. Class of the individuals that have subscribed the service of the system. It's stereotyped with ‘Profile of registry’, so every instance is associated to a profile of registry (Individual profile).

Stereotypes—Profile of registry—Lawyer. Class of the lawyers which assist a Subscriber. It's associated to the information regarding the membership in professional association of lawyers and optionally to the scanned copy of the brochure of the law firm. Furthermore, it's stereotyped with ‘Profile of registry’; so every instance is associated to a profile of registry (Individual profile).

Stereotypes—Profile of registry—Legal profile

Class of the profiles of registry for legal persons. It extends Profile of registry. The class has the following attributes: legal name; legal seat: address of legal seat; headquarters: address of headquarters; tax code; company registration number (optional). Furthermore it's associated to: legal representative: Individual profile of the legal representative; Certificate of good standing; the scanned copy of the brochure of the company.

Stereotypes—Profile of registry—Legal subscriber. Class of the legal persons that have subscribed a service. It's stereotyped with ‘Profile of registry’, so every instance is associated to a profile of registry (Legal profile).

Stereotypes—Profile of registry—Membership in professional association. Class of the information related to the membership in a professional association (i.e. the lawyers' association). It has the following attributes: number: membership identifier; date: registration date; seat: address of the seat of the professional association. The class is persistent.

Stereotypes—Profile of registry—Private institution profile. Class of the profiles of registry of a private institution. It extends Legal profile.

Stereotypes—Profile of registry—Profile of registry. Abstract class of the profiles of registry. The class has the attributes below: VAT number (if applicable); country: nationality of the person (country code ISO 3166-1 alpha-2); phone number; mobile phone number; web site: web site address; email address; expiration date: expiration date of information; useful to request a new update. The class and all its specializations are persistent.

Stereotypes—Profile of registry—Public institution profile. Class of the profiles of registry of a public institution. It extends Legal profile.

Common—Document. Class of the files, uploaded to support an Evidence. The class has the following attributes: path: the path to the resource; expiration date; language: the language of the document (ISO 639-1); reference area: the code related to the survey's section. The method getCode( ) returns the concatenation of language, reference area, reputational code of the subject of the document and the name of the file. The class is persistent.

Common—Subscriber. Abstract class of the subscribers to a service. It's stereotyped with ‘Profile of registry’, so every instance is associated to a profile of registry. The type of profile (Individual or Legal) is specified in the specialization's classes (Individual subscriber and Legal subscriber).

### 7.2—Analysis—Enumerations.

Reputation—Curriculum Vitae—Education and awards—Certification level. Enumerations of the levels of knowledge about a foreign language.

Reputation—Curriculum Vitae—Education and awards—School level. Enumerations of the school levels.

Reputation—Curriculum Vitae—Job—common—Job qualification. Enumeration of the job qualifications.

Reputation—Curriculum Vitae—Reputational data—Authority. Enumeration of the judicial authorities.

Reputation—Curriculum Vitae—Reputational data—Type of apical figure. Enumeration of the types of apical figure.

Reputation—Curriculum Vitae—Reputational data—Type of article. Enumeration of the types of article.

Reputation—Curriculum Vitae—Reputational data—Type of association. Enumeration of the types of association.

Reputation—Curriculum Vitae—Reputational data—Type of judicial process. Enumeration of the types of judicial process. This types are strictly related to the elements defined in the ‘Disputes diagram’; they are: classes that specialize Criminal Dispute; classes that specialize Civil Dispute; Fiscal Dispute class; Types of Special preventive measure.

Reputation—Curriculum Vitae—Reputational data—Type of judiciary record. Enumeration of the types of judiciary record.

Reputation—Curriculum Vitae—Reputational data—Type of publication. Enumeration of the types of publication.

Reputation—Curriculum Vitae—common—Type of author of reference. Enumeration for the types of author of a reference's letter.

Reputation—Curriculum Vitae—common—Type of award. Enumeration of the types of issuer for the awards.

Reputation—Curriculum Vitae—common—Type of encomium. Enumeration of the types of issuer for the encomiums.

Reputation—Curriculum Vitae—common—Type of habilitation. Enumeration of the types of habilitations (manually or intellectual).

Reputation—Discrepancies—State of discrepancy. Enumeration of the states of a discrepancy.

Reputation—Disputes—Type of attachment. Enumeration of the types of attachments related to a Dispute.

Reputation—Disputes—Type of document. Enumeration of the types of judicial document.

Reputation—Disputes—Type of final penalty. Enumeration of the types of final penalty.

Reputation—Disputes—Type of required title. Enumeration of the types of titles to require a refund in a Dispute.

Reputation—Disputes—Type of sentence. Enumeration of the types of sentences in a Dispute.

Reputation—Disputes—Type of special preventive measure. Enumeration of the types of special preventive measures in a Preventive judicial process.

Reputation—Disputes—Type of supervision measure. Enumeration of the types of supervision measures in a Criminal dispute.

Reputation—Disputes—Type of verdict. Enumeration of the types of verdict in a Dispute.

Reputation—State of fact. Enumeration of the states of a Fact. Only VALID facts are evaluated through the rating algorithm. A Fact can be suspended if there is a discrepancy reported (SUSPENDED_FOR_DISCREPANCY) or during the waiting time for publication (WAITING_FOR_PUBLICATION) (ie. publication of Disputes).

Stereotypes—Profile of registry—Type of certificate of good standing. Enumeration of the types of certificate of good standing.

Stereotypes—Profile of registry—Type of identity document. Enumeration of the types of identity document.

Common—Type of event. Enumeration of the system events.

Common—Type of role. Enumeration of the roles of actors related to a service.

Common—Type of service. Enumeration of the services. These services may require a payment (and may activate discounts) and may generate royalties.

### Software Implementation of the System.

The above described flow charts, shown in FIGS. 1 to 56, can be implemented at the software level through a Java Enterprise application runnable on a JEE 6 Application Server.

The target application server can be a IBM Websphere 8.5.

The application design can be based on the classic pattern Model, View, Controller, where the controllers can be implemented through Spring MVC classes (Spring MVC 3.2.1), the views through jsp pages and the business classes of the model through ejb classes and pojo classes, according to the “session façade” pattern.

Persistence can be realized using JPA 2.0 entities with Hibernate 4.1.1 Final as provider.

The target database can be IBM DB2 9.1.

The component that implements the rating algorithm can be realized through pojo classes of the business layer.

### Hardware Implementation of the System.

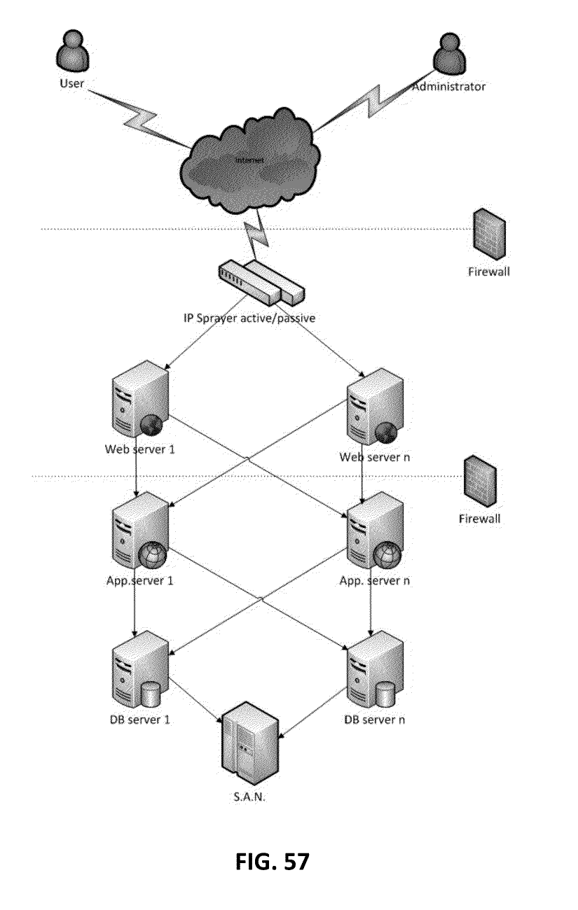

With reference to FIG. 57, an example of implementation of the Hardware level of the system of the invention is described.

A number of Users and the Administrator access the system preferably through the Internet.

The system comprises an Ip-sprayer module, a Web Server layer, an Application Server layer, a DB server layer and a storage area network SAN.

An Ip-sprayer module (Ip-sprayer active/passive) sends requests to the web layer. It gives an higher reliability to the Web Server layer. It controls and Distributes the incoming packets from the Internet network to the Web Servers, and avoids sending packets to unavailable or defective Web servers. It doesn't apply any logic to select to which web-server a request must be sent; it simply uses a round-robin strategy and it is aware of failing web-servers. It natively supports (i.e. no need of OS HA solutions) an active/passive configuration for High Availability.

A number of Web Servers (Web Server 1, . . . , Web Server n) of the web server layer receive http and https requests and route them to the app-server layer where the user session is maintained or, if the user session is not yet established, to a chosen app-server between the ready ones. An alternative to the Web Server is to use On Demand Routers (ODR) . . . . the ODR only can also act as an intelligent router, it can for example choose to route a new user session request to a particular performing app-server because the user asking it is classified as “gold-user”.

High Availability is granted by the ip-sprayer.

The Application Server layer comprises a number of Application Servers (App. Server 1, . . . App. Server n). They are a full profile Java Enterprise Edition 6 standard application servers. The application of the invention runs on it. High Availability and Load Balancing is granted by the web server layer.

DB server layer comprises a number of RDBMS servers (DB server 1, . . . . . DB server n). They can be configured as a share nothing cluster or as a shared disks cluster.

High Availability and Load Balancing is granted by internal native mechanisms or by OS HA solutions.

For the layers of Web Server, Application Server, DB Server, an example of implementation is the IBM WEBSPHERE Network Deployment, that is a standard configuration of an IBM system. The DB Server layer comprises for example IBM DB2 9.1 machines.

A Storage Area Network (S.A.N.) Provides the storage for the RDBMS servers, it's a hardware component.

Suitable Firewall equipment is inserted at certain levels of the structure, for example between the Internet and the Ip-sprayer module, and between the web server and the application server layers.

Further implementation details will not be described, as the man skilled in the art is able to carry out the invention, both at the software and hardware levels, starting from the teaching of the above description.

Many changes, modifications and variations of the subject invention will become apparent to those skilled in the art after considering the specification and the accompanying drawings which disclose preferred embodiments thereof. All such changes, modifications, variations and other uses and applications which do not depart from the scope of the invention are deemed to be covered by this invention.

What is claimed is:

1. A method for the determination of the reputational rating of natural or legal persons, comprising the following steps:
populating a database with certain pieces of information relating to said natural or legal persons, said certain pieces of information being pertinent to prove evidence or facts object of the evaluation of the reputational rating,
assigning a positive or negative weighted value to each of said certain pieces of information, proportional to a suitability factor of said evidence or facts to contribute to said determination;
determining said reputational rating of any of said natural or legal persons by summing up all the contributions derived from the weighted values relating to said natural or legal persons.

2. A method as in claim 1, wherein said step of assigning a positive or negative weighted value to each of said certain pieces of information comprises the following steps:
building up a tree structure in said database comprising: type of person, namely natural, or private legal person or public legal person; categories of evidence or facts for each type of person, subcategory of evidence or facts for each category, eventually classes of evidence or facts for each subcategory;
assigning each type of certain pieces of information to a given position in the tree structure;
assigning said positive or negative weighted value to each of said certain pieces of information on the basis of said position in the tree structure.

3. A method as in claim 2, wherein assigning said positive or negative weighted value to each of said certain pieces of information comprises:
deriving metadata from said certain pieces of information, said metadata comprising data relating to the specific type of the instances and the values of enumerated attributes of each certain piece of information,
assigning numerical values to said metadata;
obtaining said positive or negative weighted value on the basis of said metadata.

4. A method as in claim 3, wherein said step of determining said reputational rating of any of said natural or legal persons comprises calculating polynomial formulae with coefficients taken from configuration tables, said coefficients being said weighting values of the evidence or facts, and variables given by number of occurrences of the evidence or facts and time factor.

5. A method as in claim 4, wherein said time factor is such that an evidence or fact is given a higher value if more recent and a lower value if it is older.

6. A method as in claim 2, wherein, for said type of natural person, said types of certain pieces of information are assigned in said tree structure according to the following subdivision:
category of criminal reputation, subcategories of crimes, namely against the person, against the State, against the Public Administration, against property, against public faith;
category of fiscal reputation;
category of civil reputation, subcategories of civil reputation, namely family, working, breaches of contracts, extra-contractual damages, succession;
category of education reputation;
category of job reputation, subcategories of job reputation, namely employment, professional work, entrepreneurial work, family Management, civil commitment.

7. A method as in claim 2, wherein, for said type of private or public legal person, said types of certain pieces of information are assigned in said tree structure according to the following subdivision:
category of criminal reputation, subcategories of crimes, namely offences against the public administration, offences against property;
category of fiscal reputation;
category of civil reputation, subcategories of civil reputation, namely working, breaches of contracts, extra-contractual damages;
category of job reputation, subcategories of job reputation, namely working activity, civil commitment.

8. A method for the determination of the reputational rating of natural or legal persons, comprising the following steps:
populating a database with certain pieces of information relating to said natural or legal persons, said certain pieces of information being pertinent to prove evidence or facts object of the evaluation of the reputational rating,
assigning a positive or negative weighted value to each of said certain pieces of information, proportional to a suitability factor of said evidence or facts to contribute to said determination, on the basis of respective positions of said certain pieces of information in a tree structure in said database;
determining said reputational rating of any of said natural or legal persons by summing up all the contributions derived from the weighted values relating to said natural or legal persons.

9. A method as in claim 8, wherein said step of assigning a positive or negative weighted value to each of said certain pieces of information comprises the following steps:
building up said tree structure in said database comprising: type of person, namely natural, or private legal person or public legal person; categories of evidence or facts for each type of person, subcategory of evidence or facts for each category, eventually classes of evidence or facts for each subcategory;
assigning each type of certain pieces of information to said given position in the tree structure;
assigning said positive or negative weighted value to each of said certain pieces of information on the basis of said position in the tree structure.

10. A method as in claim 9, wherein assigning said positive or negative weighted value to each of said certain pieces of information comprises:
deriving metadata from said certain pieces of information, said metadata comprising data relating to the specific type of the instances and the values of enumerated attributes of each certain piece of information,
assigning numerical values to said metadata;
obtaining said positive or negative weighted value on the basis of said metadata.

11. A method as in claim 10, wherein said step of determining said reputational rating of any of said natural or legal persons comprises calculating polynomial formulae with coefficients taken from configuration tables, said coefficients being said weighting values of the evidence or facts, and variables given by number of occurrences of the evidence or facts and time factor.

12. A method as in claim 11, wherein said time factor is such that an evidence or fact is given a higher value if more recent and a lower value if it is older.

13. A method as in claim 9, wherein, for said type of natural person, said types of certain pieces of information are assigned in said tree structure according to the following subdivision:
category of criminal reputation, subcategories of crimes, namely against the person, against the State, against the Public Administration, against property, against public faith;
category of fiscal reputation;
category of civil reputation, subcategories of civil reputation, namely family, working, breaches of contracts, extra-contractual damages, succession;
category of education reputation;
category of job reputation, subcategories of job reputation, namely employment, professional work, entrepreneurial work, family Management, civil commitment.

14. A method as in claim 9, wherein, for said type of private or public legal person, said types of certain pieces of information are assigned in said tree structure according to the following subdivision:
category of criminal reputation, subcategories of crimes, namely offences against the public administration, offences against property;
category of fiscal reputation;
category of civil reputation, subcategories of civil reputation, namely working, breaches of contracts, extra-contractual damages;
category of job reputation, subcategories of job reputation, namely working activity, civil commitment.

15. A method for the determination of the reputational rating of natural or legal persons, comprising the following steps:
populating a database with certain pieces of information relating to said natural or legal persons, said certain pieces of information being pertinent to prove evidence or facts object of the evaluation of the reputational rating,
assigning a positive or negative weighted value to each of said certain pieces of information, proportional to a suitability factor of said evidence or facts to contribute to said determination, on the basis of respective positions of said certain pieces of information in a tree structure in said database;
determining said reputational rating of any of said natural or legal persons by summing up all the contributions derived from the weighted values relating to said natural or legal persons, and depending on number of occurrences of the evidence or facts in said database and time factor

16. A method as in claim 15, wherein said step of assigning a positive or negative weighted value to each of said certain pieces of information comprises the following steps:
building up said tree structure in said database comprising: type of person, namely natural, or private legal person or public legal person; categories of evidence or facts for each type of person, subcategory of evidence or facts for each category, eventually classes of evidence or facts for each subcategory;
assigning each type of certain pieces of information to said given position in the tree structure;
assigning said positive or negative weighted value to each of said certain pieces of information on the basis of said position in the tree structure.

17. A method as in claim 16, wherein assigning a positive or negative weighted value to each of said certain pieces of information comprises:
deriving metadata from said certain pieces of information, said metadata comprising data relating to the specific type of the instances and the values of enumerated attributes of each certain piece of information,
assigning numerical values to said metadata;
obtaining said positive or negative weighted value on the basis of said metadata.

18. A method as in claim 17, wherein said step of determining said reputational rating of any of said natural or legal persons comprises calculating polynomial formulae with coefficients taken from configuration tables, said coefficients being said weighting values of the evidence or facts, and variables given by number of occurrences of the evidence or facts and time factor.

19. A method as in claim 18, wherein said time factor is such that an evidence or fact is given a higher value if more recent and a lower value if it is older.

20. A method as in claim 16, wherein, for said type of natural person, said types of certain pieces of information are assigned in said tree structure according to the following subdivision:
category of criminal reputation, subcategories of crimes, namely against the person, against the State, against the Public Administration, against property, against public faith;
category of fiscal reputation;
category of civil reputation, subcategories of civil reputation, namely family, working, breaches of contracts, extra-contractual damages, succession;
category of education reputation;
category of job reputation, subcategories of job reputation, namely employment, professional work, entrepreneurial work, family Management, civil commitment.

21. A method as in claim 16, wherein, for said type of private or public legal person, said types of certain pieces of information are assigned in said tree structure according to the following subdivision:
category of criminal reputation, subcategories of crimes, namely offences against the public administration, offences against property;
category of fiscal reputation;
category of civil reputation, subcategories of civil reputation, namely working, breaches of contracts, extra-contractual damages;
category of job reputation, subcategories of job reputation, namely working activity, civil commitment.
